(19) United States
(12) Patent Application Publication
(10) Pub. No.: US 2017/0270493 A1
(43) Pub. Date: Sep. 21, 2017

(54) METHOD AND SYSTEM FOR RECORDING POINT TO POINT TRANSACTION PROCESSING

(71) Applicant: Mastercard International Incorporated, Purchase, NY (US)

(72) Inventors: Peter A. LUGLI, Seattle, WA (US); Timothy Warren MATTINGLY, Chesterfield, MO (US); Dan JULIANO, Gibsonia, PA (US)

(73) Assignee: Mastercard International Incorporated, Purchase, NY (US)

(21) Appl. No.: 15/464,942

(22) Filed: Mar. 21, 2017

Related U.S. Application Data
(60) Provisional application No. 62/311,062, filed on Mar. 21, 2016.
(60) Provisional application No. 62/433,118, filed on Dec. 12, 2016.
(60) Provisional application No. 62/434,824, filed on Dec. 15, 2016.

(51) Int. Cl. G06Q 20/10; G06Q 20/34

(52) U.S. Cl. CPC G06Q 20/10; G06Q 20/34; G06F 3/0481

(57) ABSTRACT

A method for processing a point to point payment transaction includes: receiving a first data message related to a payment transaction, storing, the first, second and third data element with a link to a record affiliated with the first data message; generating, a second data message related to the payment transaction; storing, the first data element with a link to a record affiliated with the second data message; generating a third data message related to the payment transaction, storing the first data element, and the second data element with a link to a record affiliated with the third data message, and transmitting the first data message, the second data message, the third data message for display on a graphical user interface (GUI).

### RELATED APPLICATIONS

This application claims priority to U.S. Provisional Patent Application No. 62/311,062, filed on Mar. 21, 2016; U.S. Provisional Patent Application No. 62/433,118, filed on Dec. 12, 2016; and U.S. Provisional Patent Application No. 62/434,824, filed on Dec. 15, 2016, which are herein incorporated by reference in their entirety.

### FIELD

The present disclosure relates to the recording, processing, and displaying of point to point transactions, specifically providing a trade directory of parties in a secure environment, a ledger of transactions, and the settlement of aggregated person-to-person (P2P) and business-to-business (B2B) electronic payment transactions between bank accounts and third parties using a single transaction processing system.

### BACKGROUND

Businesses rely on a complex ecosystem of technology, processes, and people internally as well as with thousands of B2B solution providers and networks to manage their invoices and make or receive payments nearly every day. With the increasing number of entities engaging in financial transactions, the number of electronic payment transactions processed each day continues to grow, with the number often being in the magnitude of hundreds of billions each day. For example, for invoiced purchases, a Buyer will approve payment to a Supplier only after validating a Purchase Order (PO), an Invoice, and a shipment confirmation related to the order—known as a ‘three-way match.’ Once approved, a payment is authorized, scheduled and disbursed. In many instances, an entity will conduct an electronic payment transaction with a payment instrument where the transaction is processed by a first payment network and then settled, where the actual funds are exchanged between the issuing and acquiring banks, by a second payment network.

Currently, existing settlement systems often operate using the settlement of individual payment transactions. For example, after a transaction is processed, the issuing bank will transfer funds for that single transaction to the settlement network, which will then forward the funds for that single transaction on to the acquiring bank. Since most businesses are not financial firms, or financially regulated, B2B transactional innovation left payment flows between the parties intact. As a result, 21st century B2B collaboration sits on an unwieldy, unconnected and largely unchanged mid-20th century B2B payments platform. As the number of transactions being processed, and therefore settled, increases, the strain on the processing power of settlement systems and those of financial institutions increases, as well as the number of fund transfers that must occur every day.

There are many issues in current B2B systems, as identified in FIG. 10. For example, there are too many unconnected methods for monitoring, making or accelerating payments. Suppliers may be left to their own costly efforts to determine credit risk of new customers. The supplier may have no real visibility into customer payment intent, adjustments to payment, or timing of payments which may be mitigated with costly collections activities and efforts. The buyer must maintain bank accounts of the supplier. The buyer may face higher bank fees for multiple payors.

Furthermore, in many cases, the heavy computing and processing power required to necessitate the settlement of such a large of volume of individual transactions may grow too great for existing settlement systems and financial institutions. Thus, there is a need for a technical solution to provide a disruptive, uniform settlement system which can reduce the amount of processing as well as the amount of communications and fund transfers. The uniform settlement system would also help to reduce the resources and processing power expended by settlement systems and financial institutions to provide for more efficient and cost-effective settlement of electronic payment transactions.

### SUMMARY

The present disclosure provides a description of systems and methods for the recording, processing, and displaying of point to point transactions. The system provides companies the ability to pay their supplies or vendors by way of a non-card payment. For example, when a supplier sends bills to its customers, typically the supplier is not accepting payments on a credit card. The supplier sends an invoice to the purchaser in order to pay the supplier on 30 or 60 days terms, etc. Most suppliers would hope to receive the funds within 30 days and hope they are paid in 30 days. However, in prior art systems, most suppliers do not have visibility of the payment posting and how the payment is actually made, which can lead to cash flow problems. The system avoids these problems by providing a platform where transaction visibility is clear to all parties involved.

The system provides solutions for moving the money, offering financial solutions around the money movement, and a rating and/or scoring service around the financial system. Additional information regarding the processing of B2B payment transactions can be found in U.S. Patent Publication No. 20160042327 A1, entitled “Method and System for Processing of Business-to Business Payment Transactions,” filed Aug. 5, 2014 by David Messina et al., which is herein incorporated by reference in its entirety.

In one implementation, a method for recording point to point payment transactions, comprises: receiving, by a receiving device of a processing system, a first transaction message related to a payment transaction, wherein the first transaction message is formatted pursuant to a standard using one or more application program interfaces (APIs) and includes at least a plurality of data elements including at least a first data element configured to store a transaction details, a second data element configured to store a primary account number, and a third data element configured to store a recipient account number; storing, in a commerce database of the processing server, the first, second and third data element with a link to a record affiliated with the first transaction message, wherein the link provides access to a document based on the first transaction message; generating, by a generation module of the processing system, a second transaction message related to the payment transaction, wherein the second transaction message is formatted pursuant to a standard using the one or more APIs and includes at least a plurality of data elements including a first data element configured to store a payment amount, the payment amount being based on at least the transaction details; storing, in the commerce database of the processing server, the first data element with a link to a record affiliated with the second transaction message, wherein the link provides access to a document based on the second transaction message; electronically transmitting, by a transmitting device of the processing system, the second transaction message to a first financial institution associated with a transaction account related to the primary account number; generating, by the generation module of the processing system, a third transaction message related to the payment transaction, wherein the third transaction message is formatted pursuant to a standard using the one or more APIs and includes at least a plurality of data elements including a first data element configured to store a settlement amount and a second data element configured to store the recipient account number, the settlement amount being based on at least the transaction details; storing, in the commerce database of the processing server, the first data element, and the second data element with a link to a record affiliated with the third transaction message, wherein the link provides access to a document based on the third transaction message; electronically transmitting, by the transmitting device of the processing system, the third transaction message to a second financial institution associated with a transaction account related to the recipient account number; and electronically transmitting, by transmitting device of the processing system, the first transaction message, the second transaction message, the third transaction message for display on a graphical user interface (GUI).

In another implementation, a system for recording point to point payment transactions, comprises: a receiving device of a processing system configured to receive a first transaction message related to a payment transaction, wherein the first transaction message is formatted pursuant to a standard using one or more application program interfaces (APIs) and includes at least a plurality of data elements including at least a first data element configured to store a transaction details, a second data element configured to store a primary account number, and a third data element configured to store a recipient account number; a commerce database of the processing server configured to store the first, second and third data element with a link to a record affiliated with the first transaction message, wherein the link provides access to a document based on the first transaction message; a generation module of the processing system configured to generate a second transaction message related to the payment transaction, wherein the second transaction message is formatted pursuant to a standard using the one or more APIs and includes at least a plurality of data elements including a first data element configured to store a payment amount, the payment amount being based on at least the transaction details; the commerce database of the processing server configured to store the first data element with a link to a record affiliated with the second transaction message, wherein the link provides access to a document based on the second transaction message; a transmitting device of the processing system configured to electronically transmit the second transaction message to a first financial institution associated with a transaction account related to the primary account number; the generation module of the processing system configured to generate a third transaction message related to the payment transaction, wherein the third transaction message is formatted pursuant to a standard using the one or more APIs and includes at least a plurality of data elements including a first data element configured to store a settlement amount and a second data element configured to store the recipient account number, the settlement amount being based on at least the transaction details; the commerce database of the processing server configured to store the first data element, and the second data element with a link to a record affiliated with the third transaction message, wherein the link provides access to a document based on the third transaction message; the transmitting device of the processing system configured to: transmit the third transaction message to a second financial institution associated with a transaction account related to the recipient account number; and transmit the first transaction message, the second transaction message, the third transaction message for display on a graphical user interface (GUI).

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the recording, processing, and displaying of point to point transactions in accordance with exemplary embodiments.

FIG. 2 is a block diagram illustrating the computing devices of FIG. 1 recording, processing, and displaying of point to point transactions in accordance with exemplary embodiments.

FIG. 3A is a flow diagram illustrating a process for settlement of a point to point transaction using a single computing device and entity systems in accordance with exemplary embodiments.

FIG. 3B is a flow diagram illustrating a process for recording, processing, and displaying of point to point transactions using a single computing device and entity systems in accordance with exemplary embodiments.

FIG. 4 is a flow diagram illustrating a process for recording, processing, and displaying of point to point transactions using multiple computing devices and third party networks in accordance with exemplary embodiments.

FIGS. 5A and 5B are flow diagrams illustrating a process for the settlement of a point to point transaction using multiple computing devices in the processing system of FIG. 1 in accordance with exemplary embodiments.

FIG. 6 is a diagram illustrating a process for recording, processing, and displaying of point to point transactions in the processing system of FIG. 1 in accordance with exemplary embodiments.

FIG. 7 is a flowchart illustrating an exemplary method for processing a point to point payment transaction in accordance with exemplary embodiments.

FIG. 8 is a flow diagram illustrating the processing of a payment transaction in accordance with exemplary embodiments.

FIG. 9 is a block diagram illustrating a computer system architecture in accordance with exemplary embodiments.

FIG. 10 is a diagram illustrating issues with current business-to-business payment systems.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

### System for Processing and Settlement of Point to Point Transactions

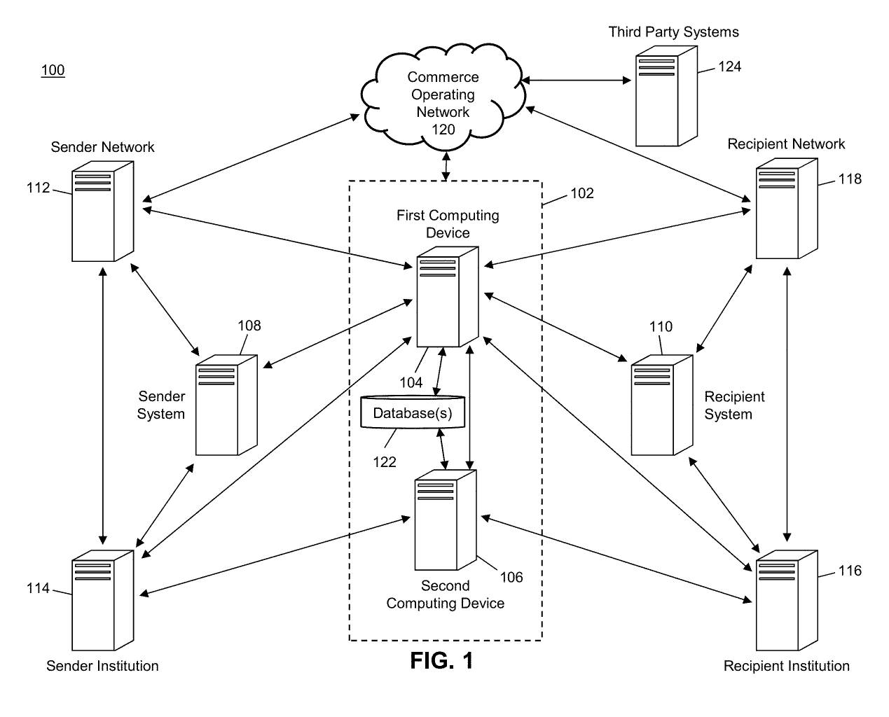

FIG. 1 is a block diagram illustrating a high level system architecture 100 for the recording, processing, and displaying of point to point transactions in accordance with exemplary embodiments.

The system may include a processing system 102. The processing system 102 may be comprised of one or more computing devices and may be configured to process and settle point to point electronic payment transactions. A point to point electronic payment transaction may be a financial transaction conducted for payment from a first transaction account to a second transaction account. In some instances, the point to point transaction may be processed and settled via the processing system 102 using account numbers directly associated with the respective transaction accounts, without the use of additional payment instruments and corresponding numbers. For example, a point to point transaction may be conducted via transaction account numbers without the use of credit cards or other types of payment cards, which may have different numbers associated therewith.

In some embodiments, the processing system 102 may be configured to perform the functions discussed herein via a single computing device. In other embodiments, the processing system 102 may include multiple computing devices, which may each be configured to perform specific functions of the processing system 102. For example, as illustrated in FIG. 1, the processing system 102 may be comprised of at least a first computing device 104 and a second computing device 106. The first computing device 104 and second computing device 106 may, as discussed in more detail below, be configured to perform processing and settlement of point to point transactions for payment from a first entity to a second entity.

In the system illustrated in FIG. 1, a sender system 108 may utilize the processing system 102 for the processing of a point to point transaction for the sending of payment to a recipient system 110. The sender system 108 and recipient system 110 may be computing systems associated with entities that are configured to perform electronic communications suitable for accomplishing the functions discussed herein, for the sending of funds from the sender system 108 or an entity associated thereto (e.g., a sending entity, such as a sending business or a sending consumer) to a recipient system 110 or entity associated thereto (e.g., a recipient entity, such as a recipient business or a recipient consumer). Sender systems 108 and recipient systems 110 may include, for example, computing systems used for account management, inventory management, accounts payable and/or receivable, etc.

The sender system 108 may initiate a point to point payment transaction for payment of a transaction amount to the recipient system 110. In some instances, the sender system 108 may electronically transmit a remittance request directly to the processing system 102 for the remittance of the transaction amount to the recipient system 110. In other instances, the sender system 108 may utilize a sender network 112. The sender network 112 may be an entity and/or computing system suitable for use in the initiation of point to point payment transactions, such as a monetary transferring entity (e.g., Western Union) or trade or supply chain network (e.g., Ariba). In some instances, the sender system 108 may be an individual that may use the sender network 112 to initiate the point to point payment transaction.

As part of the initiation of the point to point payment transaction, the sender system 108 or sender network 112 may electronically transmit a data signal to the processing system 102 that is superimposed with a remittance request. The remittance request may include at least the transaction amount to be paid, a primary account number associated with the transaction account being used by the sender to fund the payment, and a recipient account number associated with the transaction account being used by the recipient to receive the remitted funds. The transaction account being used by the sender may be issued to the sender via a sender institution 114. The sender institution 114 may be an issuing financial institution, such as an issuing bank or other suitable entity, configured to issue transaction accounts to sending entities for use in funding point to point payment transactions. In some instances, the sender institution 114 may be configured to electronically transmit remittance requests to the processing system 102. In such instances, the sender or sender system 108 may use the sender institution 114 to initiate the point to point payment transaction. For example, the sender may use a computing device (e.g., a desktop computer, laptop computer, notebook computer, tablet computer, cellular phone, smart phone, smart watch, smart television, wearable computing device, implantable computing device, etc.) to electronically transmit a data signal to the sender institution 114 superimposed or otherwise encoded with information to be included in the remittance request, such as via a web page or application program associated with the sender institution 114.

The processing system 102 may receive the remittance request. When the payment is to be made to the recipient system 110, the processing system 102 may generate a funding request for transmission to the sender institution 114 to initiate the transfer of funds. The processing system 102 may generate the funding request, which may include at least the primary account number associated with the transaction account making the payment, and the transaction amount corresponding to the payment to be made. The processing system 102 may electronically transmit a data signal superimposed or otherwise encoded with the funding request to the sender institution 114. The sender institution 114 may receive the request, may debit the transaction amount from the transaction account associated with the primary account number, and may transfer the corresponding funds to the processing system 102 using traditional methods and systems for the transfer of currency from one entity to another. In some embodiments, the processing system 102 may identify the sender institution 114 via the primary account number. For instance, the primary account number may include a bank identification number, issuer identification number, or other value associated with the sender institution 114, or the processing system 102 may otherwise store an association between the primary account number and the sender institution 114.

The processing system 102 may confirm that the appropriate funds have been received from the sender institution 114. The processing system 102 may then initiate payment of the remitted funds to the appropriate recipient institution 116. The recipient institution 116 may be an acquiring financial institution, such as an acquiring bank or other suitable entity, configured to issue transaction accounts to recipient entities for use in receiving payment in point to point payment transactions. The processing system 102 may generate a settlement notice, which may indicate to the recipient institution 116 the transaction amount being paid for the point to point payment transaction and the transaction account to which the amount is being paid. The settlement notice may thus include at least the recipient account number and transaction amount from the remittance request previously submitted to the processing system 102. The processing system 102 may electronically transmit a data signal superimposed or otherwise encoded with the generated settlement notice to the recipient institution 116. The processing system 102 may also transfer the appropriate funds to the recipient institution 116 using traditional methods and systems for the transfer of currency from one entity to another.

The recipient institution 116 may credit the transaction account associated with the recipient entity that corresponds to the recipient account number included in the settlement notice with the transaction amount, to effect the payment to the recipient entity. Following the payment by the processing system 102 to the recipient institution 116, the recipient entity may be informed of the settlement of the point to point payment transaction. In some embodiments, the processing system 102 may generate a settlement notification, which may include at least the transaction amount, which may be electronically transmitted to the recipient system 110. In other embodiments, the processing system 102 may electronically transmit the settlement notification to a recipient network 118 for forwarding to the recipient system 110 or for other distribution to a recipient entity, such as via a web page, application program, short messaging service message, etc. The recipient network 118 may be an entity and/or computing system suitable for use in the notification and management of point to point payment transactions, such as a monetary transferring entity (e.g., Western Union) or trade or supply chain network (e.g., Ariba). In some instances, the sender network 112 and recipient network 118 may be the same entity for one or more point to point payment transactions. In some embodiments, the recipient institution 116 may be configured to provide a settlement notice to the recipient system 110 or recipient entity following receipt of the settlement funds from the processing system 102 using traditional methods of communication between the recipient institution 116 and a recipient entity.

In some embodiments, the processing system 102 may be configured to aggregate point to point payment transactions for aggregated settlement thereof. In such embodiments, the processing system 102 may receive a plurality of remittance requests, each for a different point to point payment transaction. Each remittance request may include a primary account number, a transaction account number, and a recipient account number. In some instances, each remittance request may include a unique primary account number and/or recipient account number. In other instances, one or more remittance requests may have a common primary account number and/or recipient account number, such as for the point to point payment of funds from one sending entity to several recipient entities, or the receipt of funds from multiple sending entities by a single recipient entity.

The processing system 102 may be configured to aggregate remittance requests for sender institutions 114 and recipient institutions 116 to reduce the number of fund transfers associated therewith. In the former instance, the processing system 102 may aggregate remittance requests that include the same primary account number or where each included primary account number is associated with the sender institution 114, such as by having the same bank identification number, issuer identification number, or other identifying value. In some cases, the processing system 102 may be configured (e.g., as requested by the sender institution 114) to aggregate transactions on an account level (e.g., remittance requests having the same primary account number) or on an entity level (e.g., all remittance requests with primary account numbers associated with the sender institution 114). In some instances, account level aggregation may use multiple primary account numbers, such as in instances where a single sender system 108 may utilize multiple transaction accounts that may be aggregated by the sender institution 114. Aggregation of the remittance requests may include the generation of a single funding request for a payment amount corresponding to the summation of each of the transaction amounts from each aggregated remittance request (e.g., which may be increased or decreased based on additional criteria, such as processing fees). In some instances, the funding request may indicate each primary account number and the corresponding payment amount, such as for use by the sender institution 114 in debiting the appropriate amount from each corresponding transaction account.

The processing system 102 may electronically transmit a data signal superimposed or otherwise encoded with the single funding request for the aggregated remittance requests to the sender institution 114. The sender institution 114 can then debit each transaction account accordingly and make a single fund transfer for the total payment amount to the processing system 102. As a result, the sender institution 114 may provide payment for a plurality of point to point transactions via a single fund transfer and via a single funding request, which may reduce the number of fund transfers and associated communications, thereby reducing computing and processing power necessary for the sender institution 114 and associated fees and expenses.

The processing system 102 may also be configured to perform aggregation related to the payment of settlement funds to recipient institutions 116. The processing system 102 may aggregate remittance requests for a recipient institution 116 by aggregating remittance requests that include a common recipient account number (e.g., for account level aggregation) or that include a recipient account number having a common bank identification number, issuer identification number, or other identifying value that is associated with the recipient institution 116 (e.g., for entity level aggregation). Aggregation of the remittance requests for the recipient institution 114 may include aggregation of the respective transaction amounts into a single settlement amount, which may be increased or decreased based on additional criteria, such as for the payment of processing fees. The processing system 102 may generate a single settlement notice, which may include the aggregated settlement amount, and may also include each recipient account number and corresponding transaction amount for use by the recipient institution 116 in the crediting of the corresponding transaction accounts.

The processing system 102 may electronically transmit a data signal to the recipient institution 116 superimposed or otherwise encoded with the single settlement notice. The processing system 102 may also initiate the transfer of the full settlement amount to the recipient institution 116. The recipient institution 116 may receive the settlement amount, and may credit each transaction account for recipient entities accordingly based on the data included in the settlement notice. As a result, the recipient institution 116 may receive payment for a plurality of point to point transactions via a single fund transfer and via a single settlement notice, which may reduce the number of fund transfers and associated communications, thereby reducing computing and processing power necessary for the recipient institution 114 and associated fees and expenses. In instances where the processing system 102 performs aggregation for both the sender institution 114 and recipient institution 116, settlement may be performed for thousands, millions, and even billions of payment transactions via only a handful of funding requests, settlement notices, and fund transfers.

The processing system 102 may be configured to use various criteria for the determining the number of remittance requests to be aggregated for aggregated funding and/or settlement for point to point transactions. In such instances, the criteria may be set forth by the processing system 102 or the applicable sender institution 114 and/or recipient institution 116. The criteria may include, for example, the number of remittance requests, the total payment or settlement amount, the number of primary account numbers or recipient account numbers, time and/or date, etc. For instance, a sender institution 114 may request a single funding request daily, where all remittance requests each day are aggregated, or may request funding requests each time the aggregated payment amount reaches a predetermined value. In some cases, multiple criteria may be used, such as the aggregation of settlement amounts for settlement at the end of each day with additional settlement notices and transfers provided if the settlement amount exceeds $100,000.

In some instances, a single entity may be both a sender institution 114 and a recipient institution 116 in a plurality of remittance requests received by the processing system 102. In such an instance, the aggregation of the remittance requests involving the entity may include aggregating remittance requests where they are associated with the primary account number sending the funds, as well as remittance requests where they are associated with the recipient account number receiving the funds. The aggregation may involve a balancing of the remittance amount to be paid by the single entity for the remittance requests for which they are the sender institution 114 against the settlement amount to be paid to the single entity for remittance requests for which they are the recipient institution 116. For example, the entity may be required to fund $100,000 in remittance, but may be entitled to $80,000 in settlement. In such an example, the processing system 102 may transmit a single funding request to the single entity for $20,000 to accommodate for the difference in the remittance and settlement amounts.

In some embodiments, the processing system 102 may operate in conjunction with sender systems 108, recipient systems 110, sender networks 112, and/or recipient networks 118 using a commerce operating network 120 for the processing of point to point payment transactions for business to business transactions that may include the use of reconciliation data. Reconciliation data may include data used by the sending entity and/or recipient entity for the tracking of point to point transactions, such as invoice numbers, purchase order numbers, line item product details, etc. In such instances, remittance requests may include reconciliation data. The processing system 102 may be configured to include the reconciliation data in settlement notices that are electronically transmitted to the recipient system 110 (e.g., or recipient network 118, as applicable) for the corresponding point to point payment transaction, such as based on the recipient account number included therein. In some cases, reconciliation data may only be included in communications between the processing system 102 and sender systems 108, sender networks 112, recipient systems 110, and recipient networks 116. In such cases, funding requests transmitted to sender institutions 114 and settlement notices transmitted to recipient institutions 116 may not include reconciliation data.

In some embodiments, the processing system 102 may be configured to perform processing and settlement for point to point payment transactions that involve multiple currencies. In such embodiments, the sending entity may submit the remittance request with a currency designation for the remittance or settlement, as well as the desired remittance or settlement amount. The processing system 102 may then perform any necessary conversions of the currency for remittance and/or settlement, which may be based on exchange rates for each involved currency. In some instances, the processing system 102 may provide the sending entity (e.g., via the sender network 112 or sender system 108) with exchange rates that may be used. Such exchange rates may be set by the processing system 102, sender institution 114, recipient institution 116, or other entity, such as being a market exchange rate. In some such instances, the processing system 102 may indicate a period of applicability for in an exchange rate. In an example, the sending entity may want to send 1,000 in USD, to be received by the recipient entity in GBP. The processing system 102 may calculate the GBP amount equivalent to 1,000 USD for the settlement. In another example, the sending entity may want to send enough currency in USD for a recipient entity to receive 1,000 in GBP. In such an example, the processing system 102 would calculate the equivalent of 1,000 GBP in USD to use as the remittance amount for the payment transaction. In such embodiments, exchange rate and currency conversion data may be included in funding requests and/or settlement notices.

In some embodiments, the processing system 102 may be configured to use the multiple computing devices for performing the functions discussed herein. In such an embodiment, the first computing device 104 may be configured to receive remittance requests from sender systems 108, sender networks 112, and sender institutions 114 and may be configured to perform aggregation of remittance requests, if applicable. The first computing device 104 may transmit data included in the remittance requests or the aggregated data to the second computing device 106 using internal communication networks and methods. The second computing device 106 may generate the corresponding funding requests and electronically transmit the data signals with the funding requests superimposed or encoded thereon to the applicable sender institutions 114, and may confirm the receipt of the corresponding payment amounts.

The second computing device 106 may also be configured to generate settlement notices for electronic transmission to the recipient institutions 116 and initiate the transfer of funds thereto. In some instances, the first computing device 106 may first transfer a signal to the second computing device 106 to initiate the payment of settlement amounts. For example, the first computing device 106 may be configured to confirm that full payment has been received for an aggregated settlement amount, such as in instances where a recipient institution 116 is to receive an aggregated settlement amount that originates from multiple sender institutions 114. The first computing device 104 may also be configured to generate settlement notices for electronic transmission to the recipient systems 110, recipient networks 118, and/or recipient institutions 116, as applicable, for notifying recipient entities of the receipt of funds.

In some embodiments, the processing system 102 may be used to store data associated with the entities involved in the payment transactions, such as for storage in a ledger accessible by each of the entities, and, in some instances, additional third party entities. The processing system 102 may be configured to store data associated with payment transactions that are settled between a sending entity and a recipient entity. In the case of business-to-business (B2B) transactions, the processing system 102 may store reconciliation data for the payment transactions, such as may be used by the sending entity and recipient entity in performing additional functions related to the payment transactions. For example, the processing system 102 may store identification information associated with each entity in a ledger in a database 122, and may also store status information regarding purchase orders, invoices, payments, etc. for a payment transaction, and additional information regarding each entity, such as corporate identity data, data associated with individuals of each respective entity that may have authority over payment transactions and financial decisions, transaction account details, etc. Such a ledger may thus include a complete look at the entity and the transactional history between the entity and other sender and recipient entities.

In an example, a company may register with the processing system 102 for use in the system discussed herein. The company may then be registered in a trade directory (e.g., a ledger stored in the database 122), where their bank account information may be in the system, along with additional data associated with the company, such as whoever is responsible for Accounts Payable (AP) or Accounts Receivable (AR), financial and treasury officers, authorized individuals for the company's financial transactions and purchase orders and/or invoices, etc. The trade directory may also store data associated with future invoices and payments that are made via the processing system 102. As a result, over time, every purchase order, invoice, and transaction between the registered entity and any other enabled parties, or status thereof (that is, without a full copy of the underlying transactions themselves being captured or stored), may be captured in the ledger. The trade directory may also be used to store, for instance entity attributes (e.g., entity or core organization level data), payment attributes (e.g., payment/account detail data, remittance data, etc.), entity hierarchy (e.g., relationships, organizational structure, subsidiaries, etc.), affiliated entity data (e.g., buyers, suppliers, network relationships, etc.), supplemental data (e.g., certifications, documents, etc.), associated individuals, etc.

The first computing device 104 and/or the second computing device 106 may capture the information for use in the ledger via one or more application program interfaces (APIs). APIs may pull or receive the essential information (e.g., transaction amount, invoice date, quantity of item, shipment date, etc.) from invoices, purchase orders, and other items related to a payment transaction, which may then be stored into the ledger. In some instances, the APIs may provide for the storage of a link in the ledger to the associated invoice, purchase order, and/or any other transaction correspondence, such as via a link to an external application program or B2B Network that may be used to submit the transaction corresponding to the processing system 102. For example, the API in the processing system 102 may communicate with a trade network, and may receive purchase orders and invoices from the trade network for sender and recipient entities, or status thereof, that is, without a full copy of the purchase orders or invoices themselves, and may include links in the ledger to the purchase orders and invoices at the trade network. Thus, the sender system 108 and/or the recipient system 110 may access the ledger to see any transaction details, as well as to link back to the original correspondence.

In some instances, the processing system 102 may also provide status information to the entities for payment transactions. For example, as the APIs update the transactional data stored in the ledger, each entity may access the data to identify status for their transactions, via their respective systems (e.g., sender system 108, recipient system 110, etc.) or networks (e.g., sender network 112, recipient network 118, etc.). For example, a sender entity may initiate the transfer of funds to the recipient entity using the methods discussed above, and may use the processing system 102 to identify when the recipient has received the funds via the ledger. In another example, a recipient entity may send an invoice to a sender entity and may, via the ledger, identify when the sender entity has received the invoice as the status in the ledger changes due to the receipt of transaction correspondence via the APIs.

In addition, the processing system 102 may also act as a centralized trust and repository of all the processed payment transactions such that, for example, third-party financial providers can look at the history of transactions involving an entity and validate risk and offer financial solutions to that entity based thereon. For example, a financial provider may provide a loan or acquire a receivable due to a recipient entity on the strength of their expected payment for a number of outstanding invoices, which may be verified via the trusted repository of transaction data that is included in the ledger maintained by the processing system 102. The processing system 102 may also provide a robustness and trustworthiness of the data, such that regulatory authorities can potentially rely on the trustworthiness to effectively outsource licensing requirements, regulatory requirements, and any other issues that accompany identity of parties and individuals. For example, a regulatory agency may contact the processing system 102 and access transactional data or trading partner identity data stored in the ledger for use in verifying compliance with rules and regulations.

In some embodiments, the system may include one or more third party systems 124. The third party systems 124 may be, for example, different companies that may provide funds to borrow or sell receivables on a non-recourse basis, at an interest rate or other entities that may be benefited by the use of the transaction ledger stored in the processing system 102. For instance, a recipient entity may opt in to allow third party systems 124 to view the ledger with respect to their transactions. The third party systems 124 may access a view of the recipient entity's transactions in the trade directory that is compliant with privacy concerns and with the consent of all parties involved in the transaction (e.g., where sender entity information is anonymized or used with the entity's consent). The third party systems 124 may analyze the price risk and offer financial solutions to, for example, the recipient entity for a particular invoice. For example, the third party system 124 may provide the ability for the recipient entity to get on-demand cash. Instead of waiting until day 30 or day 40 for the recipient entity to receive their cash via the settlement processed, based on the history of transactions between the supplier and the purchaser the third party system 124 may see that the sender entity pays 99.9 percent of their invoices in full and so the third party system 124 may have a high degree of comfort based on the data from the ledger that the sender entity will pay the next invoice due but not yet paid to that supplier. As a result, the third party system 124 may offer a very low annual percentage rate (APR) to that recipient entity to advance cash on the strength of the comfort identified via the ledger. In some cases, the processing system 102 may also track the offer from the third party system 124 and log it into the trade directory. In such cases, when the processing system 102 is looking to disburse funds to the recipient institution 116 for payment to the recipient entity, the processing system 102 may initiate the settlement directly to the recipient institution 116 and may indicate that payment is not to be made to the recipient entity as payment was already provided by a third party system 124. In such instances, the settlement notice provided to the recipient institution 116 may indicate that the third party system 124 is to be paid, or may indicate in the settlement notice to the recipient entity that payment made from the recipient institution 116 is for the cash advance provided by the third party system 124.

In some embodiments, the ledger may be a blockchain configured to store the associated data. A blockchain may be comprised of a plurality of blocks, wherein each block is comprised of at least a block header and one or more data values. Each block header may include a timestamp as well as a reference value referring to the block header of the previous block added to the blockchain and a reference value referring to the one or more data values included in the respective block. In an exemplary embodiment, the reference value may be a hash value generated via the application of one or more hashing algorithms to the respective data. For instance, the reference value to a previous block header may be a hash value generated via hashing of the block header of the previous (e.g., based on timestamp) block. As such, the blockchain may be immutable, as a change in any data value would result in a change to the hash value included in the respective block's block header, also resulting in a change in the hash value of the subsequent block's block header, which would carry through the remaining blocks in the blockchain, thus preventing modification to any data values or data in the blockchain. In the system 100, the data values may include the purchase orders, invoices, transaction data, and other data stored in the ledger as discussed herein.

In some embodiments, the communications between the entities of the system illustrated in FIG. 1 and discussed herein may be formatted pursuant to one or more standards. The standards may include, for example, standards issued by the International Organization of Standardization. For example, remittance requests may be formatted pursuant to the ISO 8583 standard, and funding requests may be formatted pursuant to the ISO 20022 standard. In some embodiments, each communication performed in the system illustrated in FIG. 1 may use a single standard, such as all communications performed using the ISO 8583 standard or the ISO 20022 standard. In other embodiments, multiple standards may be used. For example, remittance requests received from sender networks 112 and/or sender systems 108 and settlement notices transmitted to recipient networks 118 and/or recipient systems 110 may be formatted pursuant to the ISO 8583 standard, while funding requests transmitted to sender institutions 114 and settlement notices transmitted to the recipient institutions 116 may be formatted pursuant to the ISO 20022 standard. In some such embodiments, the functions of the processing system 102 may be performed by the different computing devices based on the standards associated therewith. For example, the first computing device 104 may be configured to receive, generate, and transmit communications formatted pursuant to the ISO 8583 standard, while the second computing device 106 may be configured to receive, generate, and transmit communications formatted pursuant to the ISO 20022 standard.

Data messages formatted pursuant to a standard may include data elements configured to store data as set forth in the associated standard. For example, the standard may indicate the data elements to be included in data messages formatted pursuant to the standard and the data to be stored therein. In some instances, data messages formatted pursuant to different standards may include the same data, with the data being included in different data elements. For example, a remittance request formatted pursuant to the ISO 8583 standard may include data elements configured to store the primary account number and transaction amount, while the corresponding funding request formatted pursuant to the ISO 20022 may also include data elements configured to store the primary account number and transaction amount, with the respective data being included in different data elements in the data message as a whole, and with the data being stored in each data message being formatted differently.

In embodiments where multiple standards may be used, the processing system 102 and/or a computing device included therein may be configured to convert data signals and/or data messages superimposed or otherwise encoded thereon from one standard to another standard. For example, the first computing device 104 may be configured to convert a remittance request from the ISO 8583 standard to the ISO 20022 standard prior to delivery to the second computing device 106. In such an example, the conversion of a remittance request to the ISO 20022 standard may convert the remittance request to a funding request for transmission to the sender institution 114. In some embodiments, conversion may be performed by a third party entity. For example, the processing system 102 may electronically transmit a data signal to a third party entity that is superimposed or otherwise encoded with a data message formatted pursuant to a first standard, and may receive a data signal back from the third party entity that is superimposed or otherwise encoded with the data message formatted pursuant to a second standard. In cases where the processing system 102 may be comprised of multiple computing devices, the first computing device 104 may electronically transmit the data signal to the third party entity, while the second computing device 104 may receive the data signal electronically transmitted by the third party entity.

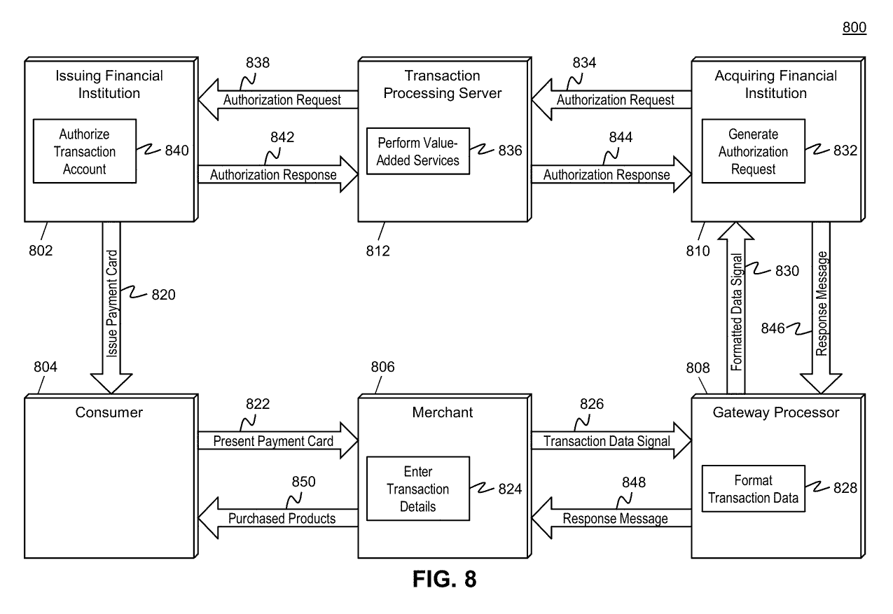

Communications performed by the processing system 102 as discussed herein may use any suitable communication network and associated protocols and method of communication. Suitable communication networks may include, for example, a payment network and associated payment rails, a local area network, wireless area network, radio frequency network, cellular communication network, the Internet, etc. In some instances, the processing system 102 may be part of a payment network configured to perform processing of payment transactions, where one or more of the communications discussed herein may be performed using the associated payment rails. For example, data signals transmitted to and/or from the sender institution 114 and recipient institution 116 may be performed using the payment rails associated with a payment network. In some instances, multiple communication networks may be used. For example, the processing system 102 may communicate with sender institutions 114, recipient institutions 116, sender networks 112, and recipient networks 118 using payment rails associated with a payment network, but may communicate with sender systems 108 and recipient systems 110 using the Internet. The transmission of specially formatted transaction messages using payment rails associated with a payment network and the traditional processing of payment transactions based thereon is discussed in more detail below with respect to the process 800 illustrated in FIG. 8.

In some embodiments, the processing system 102 may be configured to perform mapping of primary account numbers and/or recipient account numbers. For example, in some instances a sender system 108 or recipient system 110 may use an alternative payment instrument for the sending or receipt of funds, respectively. In such instances, the primary account number or recipient account number may be associated with the payment instrument and not directly associated with the transaction account used to send or receive the funds, as applicable. The processing system 102 may be configured to replace the primary account number or recipient account number with an alternative number mapped thereto that corresponds directly to the associated transaction account. For example, the sending entity may use a credit card to send funds to a recipient entity's bank account. In such an example, the processing system 102 may swap the credit card number included in the remittance request with the account number for the underlying transaction account prior to the submitting of a funding request to the sender institution 114. In such embodiments, the processing system 102 may store one or more databases suitable for use in storing associations between account numbers for use in mapping.

### Computing Device

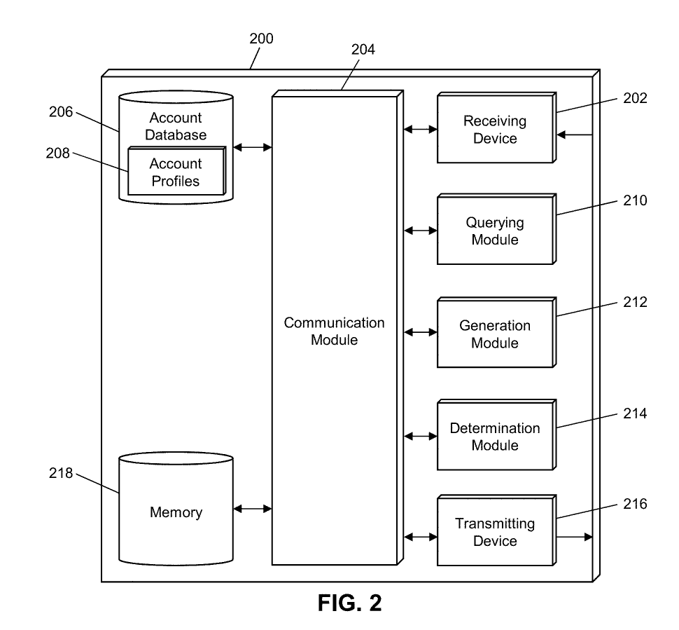

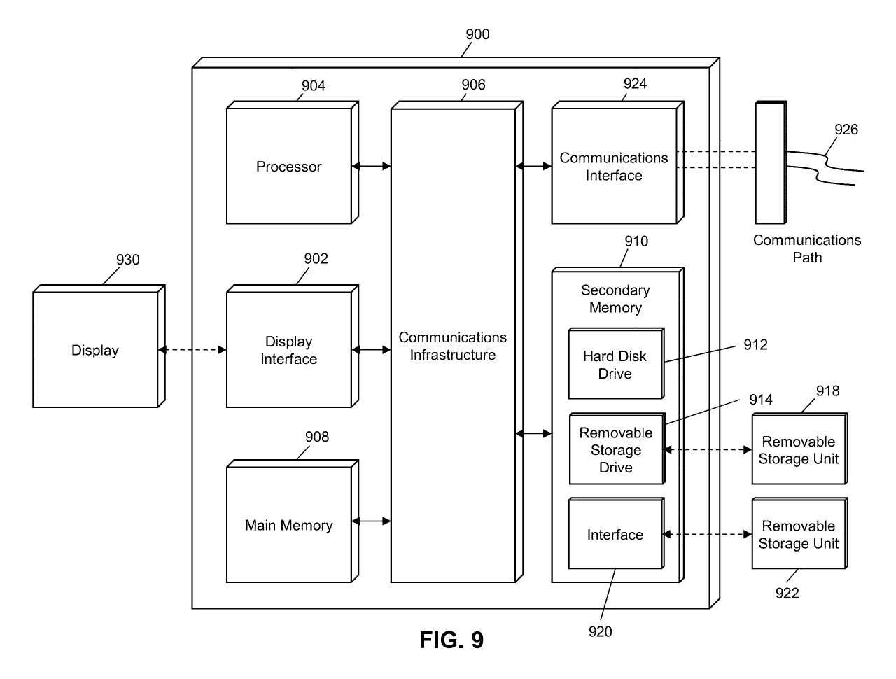

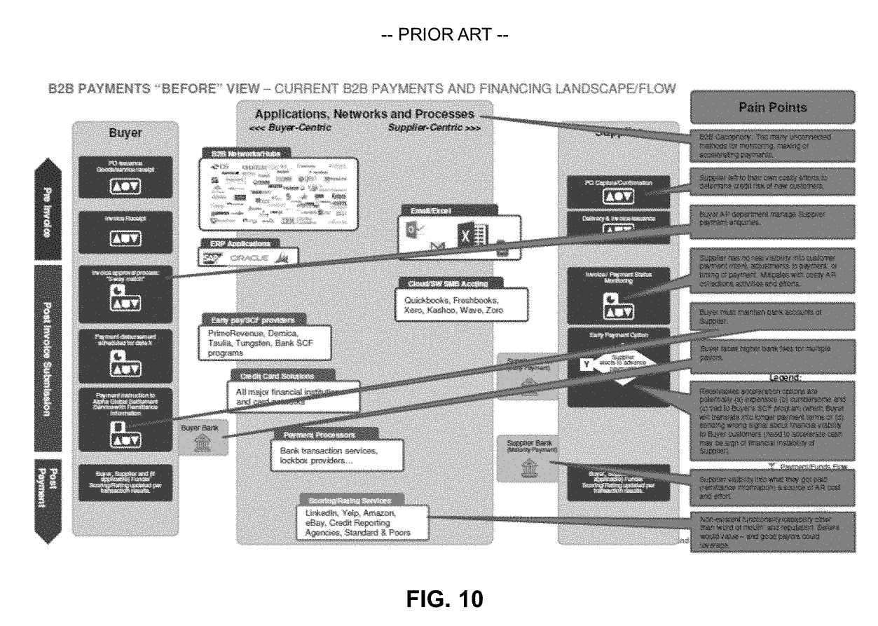

FIG. 2 is a block diagram illustrating a computing device 200 of the processing system 102, such as the first computing device 104 or second computing device 106, illustrated in the system 100 of FIG. 1 for the recording, processing, and displaying of point to point transactions in accordance with exemplary embodiments. It will be apparent to persons having skill in the relevant art that the embodiment of the computing device 200 illustrated in FIG. 2 is provided as illustration only and may not be exhaustive to all possible configurations of the computing device 200 suitable for performing the functions as discussed herein. For example, the computer system 900 illustrated in FIG. 9 and discussed in more detail below may be a suitable configuration of the computing device 200.

The computing device 200 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks for the transmission of transaction messages that include sensitive financial data and information. In some instances, the receiving device 202 may also be configured to receive data from sender systems 108, sender networks 112, sender institutions 114, other computing devices, recipient systems 110, recipient networks 118, recipient institutions 116, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by sender systems 108, sender networks 112, and/or sender institutions 114 that are superimposed or otherwise encoded with remittance requests. Remittance requests may include primary account numbers, transaction amounts, and recipient account numbers. In some instances, remittance requests may be formatted pursuant to one or more standards, such as the ISO 8583 or ISO 20022 standards. In some instances, remittance requests may only be received by receiving devices 202 in the first computing device 104 in the processing system 102. The receiving device 202 may also be configured to receive data signals electronically transmitted by other computing devices 200. For example, the receiving device 202 of the second computing device 106 may receive a data signal electronically transmitted by the first computing device 104 for aggregated remittance requests for use in generating funding requests. The receiving device 202 may also be configured to receive currency via monetary transfers using traditional methods and systems. In some embodiments, the receiving device 202 may be further configured to receive data signals electronically transmitted from third party entities, such as may be superimposed or otherwise encoded with converted data messages.

The receiving device 202 may also be configured to receive transaction messages related to payment transactions, such as from sender networks 112, recipient networks 118, payment networks, or other entities involved in the processing of payment transactions. The transaction messages may be formatted pursuant to one or more standards, and may be received using one or more application program interfaces (APIs). Each transaction message may include at least a plurality of data elements including at least a first data element configured to store transaction details, a second data element configured to store a primary account number, and a third data element configured to store a recipient account number. In some instances, the receiving device 202 may also receive additional data messages related to payment transactions, such as may include data related to transaction correspondences, such as purchase orders, invoices, etc. In some instances, the data messages received by the receiving device 202 may be formatted using various data formatting standards, and may be reformatted upon receipt by the receiving device 202 or other module or engine of the computing device 200, such as via the API.

The computing device 200 may also include a communication module 204. The communication module 204 may be configured to transmit data between modules, engines, databases, memories, and other components of the computing device 200 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the computing device 200 and external components of the computing device 200, such as externally connected databases, display devices, input devices, etc. The computing device 200 may also include a processing device. The processing device may be configured to perform the functions of the computing device 200 discussed herein as will be apparent to persons having skill in the relevant art. In some embodiments, the processing device may include and/or be comprised of a plurality of engines and/or modules specially configured to perform one or more functions of the processing device, such as a querying module 210, generation module 212, determination module 214, etc. As used herein, the term “module” may be software or hardware particularly programmed to receive an input, perform one or more processes using the input, and provide an output. The input, output, and processes performed by various modules will be apparent to one skilled in the art based upon the present disclosure.

The computing device 200 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to one or more transaction accounts. In some embodiments, each account profile 208 may be associated with a single transaction account, such as corresponding to a sending or recipient entity. In such an embodiment, the account profile 208 may include data suitable for use in identifying the associated sender institution or recipient institution 116, or for use in swapping account numbers for account number mapping if applicable, such as in instances where alternative payment instruments may be used. In other embodiments, each account profile 208 may be associated with a sender institution 114 or recipient institution 116. In such embodiments, the account profile 208 may include data associated therewith used in the aggregation of remittance requests, such as aggregated payment and settlement amounts, associated identifying values (e.g., used in identifying remittance requests for association therewith), and other data suitable for performing the functions discussed herein.

In some implementations, each account profile 208 may further include information associated with the identity of the related entity (e.g., payor, payee, buyer, supplier, etc.). Each account profile 208 may store, for example, entity information, corporate identity data, data associated with individuals within the entity that have authority over banking and financial transactions and/or actual bank account information, etc. An account profile 208 may also include the first, second, and third data element of a transaction message or other data message associated with the related entity with a link to a record affiliated with the transaction or data message. The link may provide access to a document based on the first transaction message. For example, a data message related to a purchase order or data parsed therefrom may be stored in an account profile 208, which may also include a link to the related purchase order (e.g., accessible via an external entity, such as a sender network 112 or recipient network 118 via the corresponding API). In some instances, the data message itself may be stored in the account profile 208. In other instances, the account profile 208 may include transactional data parsed from the data message, such as sender entity and recipient entity identifying information, transaction amount, date of submission, etc. The account profile 208 may also store any number of additional transaction details related to payment transactions involving using APIs to gather the key information. The links stored in the account profile 208 may provide access to the original invoice, purchase order, and/or any other correspondence related to the transaction.

The computing device 200 may include a querying module 210. The querying module 210 may be configured to execute queries on databases to identify information. The querying module 210 may receive one or more data values or query strings, and may execute a query string based thereon on an indicated database, such as the account database 206, to identify information stored therein. The querying module 210 may then output the identified information to an appropriate engine or module of the computing device 200 as necessary. The querying module 214 may, for example, execute a query on the account database 206 to identify an account profile associated with a remittance request (e.g., received by the receiving device 202) based on the bank identification number, issuer identification number, or other identifying value included in a primary account number and/or recipient account number stored in the corresponding data element (e.g., as set forth in the associated standard), such as for use in performing aggregation or the transmission of communications thereto.

The computing device 200 may also include a generation module 212. The generation module 212 may be configured to generate data messages suitable for use by the processing system 102 in performing the functions discussed herein. The generation module 212 may receive instructions for the generation of data messages as input and data suitable for use therewith, may generate the requested data messages, and may output the generated data messages to another module or engine of the computing device 200. The generation module 212 may be configured to generate funding requests. Funding requests may include at least a primary account number and an associated payment amount. In some instances, the generation module 212 may generate funding requests for an aggregation of remittance requests, which may include an overall payment amount and a plurality of different primary account numbers and associated payment amounts. The generation module 212 may also be configured to generate settlement notices. Settlement notices for transmission to recipient institutions 116 may include at least one recipient account number and associated settlement amount, or may include an aggregated settlement amount and a plurality of recipient account numbers and associated settlement amounts. Settlement notices for transmission to recipient systems 110 and/or recipient networks 118 may include at least settlement amounts, and may also include reconciliation data or other data that may be useful for notifying a recipient in a point to point payment transaction.

In some instances, the generation module 212 may be configured to generate data messages pursuant to one or more standards, such as the ISO 8583 and ISO 20022 standards. In some cases, a generation module 212 may be configured to generate data messages pursuant to a single standard. For example, the generation module 212 of the first computing device 104 may be configured to generate data messages formatted pursuant to the ISO 8583 standard, while the generation module 212 of the second computing device 104 may be configured to generate data messages formatted pursuant to the ISO 20022 standard. In some embodiments, a generation module 212 may be configured to convert data messages from one format to another. Conversion of a data message may include the reformatting of one or more data elements and the reorganization of data elements included therein, as well as the addition or removal of data as set forth in the associated standards. For example, the generation module 212 may be configured to convert a data message formatted pursuant to the ISO 8583 standard for compliance with the ISO 20022 standard, which may include the movement of data in one or more data elements and the reorganization thereof.

In some implementations, the generation module 212 may be configured to generate a second data message related to a payment transaction. The second data message may be formatted pursuant to one or more standard and may include at least a plurality of data elements, including a first data element configured to store a payment amount, the payment amount being based on at least the transaction details. The generation module 212 may also be configured to generate a third data message related to the payment transaction. The third transaction message may be formatted pursuant to one or more standards and may include at least a plurality of data elements, including a first data element configured to store a settlement amount and a second data element configured to store the recipient account number. The settlement amount may be based on at least the transaction details. The generation module 212 may also be configured to generate a fourth data message related to the payment transaction. The fourth data message may formatted pursuant to one or more standards and include a plurality of data elements including at least a first data element configured to store the transaction details and a second data element configured to store the recipient account number.

The computing device 200 may also include a determination module 214. The determination module 214 may be configured to perform one or more determinations related to the functions performed by the processing system 102 as discussed herein. The determination module 214 may receive an instruction for a determination and accompanying data, may make the determination, and may output a result of the determination to another module or engine of the computing device 200. For example, the determination module 214 may be configured to determine receipt of remittance funds from a sender institution 114 for one or more remittance requests. The determination may be based on the receipt (e.g., via the receiving device 202) of a notification associated therewith, the monitoring of a transaction account and its balance, and other suitable method. The determination module 214 may also be configured to determine aggregated payment and settlement amounts for a plurality of remittance requests. Amounts may be aggregated based on commonality in primary account numbers or recipient account numbers, as applicable, which may include identifying values included therein.

In some embodiments, the determination module 214 may be configured to perform reconciliation of funds received from a sender institution 114. Reconciliation may include the determination of remittance requests that correspond to funds received from a sender institution 114. For example, a sender institution 114 may transfer remittance funds for a plurality of different remittance requests (e.g., based on an aggregated funding request), and the determination module 214 may determine which remittance requests received by the receiving device 202 were successfully funded via the received funds. The determination may then be used to determine which remittance requests have been fulfilled for settlement thereof. For example, if the processing system 102 is aggregating transfers of settlement payments to recipient institutions 116, reconciliation performed by the determination module 214 may include determining when all remittance requests associated with a recipient institution 116 (e.g., based on the recipient account number) have had their funds received from the corresponding sender institutions 114.

In some embodiments, settlement funds may be transferred to a recipient institution 116 prior to receipt of all the funds for corresponding remittance requests from sender institutions 114. For example, the processing system 102 may have an agreement with a recipient institution 116 for payment of funds thereto, where the determination module 214 may determine if settlement payment is suitable based thereon. In another example, settlement funds may be transferred to a recipient institution 116 when a predetermined amount of the funds have been received from sender institutions 114, which may be determined by the determination module 214.

The computing device 200 may also include a transmitting device 216. The transmitting device 216 may be configured to transmit data over one or more networks via one or more network protocols. In some embodiments, the transmitting device 216 may be configured to transmit data over the payment rails, such as using specially configured infrastructure associated with payment networks for the transmission of transaction messages that include sensitive financial data and information, such as identified payment credentials. In some instances, the transmitting device 216 may be configured to transmit data to other computing devices 200, sender systems 108, sender networks 112, sender institutions 114, recipient systems 110, recipient networks 118, recipient institutions 116, and other entities via alternative networks, such as the Internet. In some embodiments, the transmitting device 216 may be comprised of multiple devices, such as different transmitting devices for transmitting data over different networks, such as a first transmitting device for transmitting data over the payment rails and a second transmitting device for transmitting data over the Internet. The transmitting device 216 may electronically transmit data signals that have data superimposed that may be parsed by a receiving computing device. In some instances, the transmitting device 216 may include one or more modules for superimposing, encoding, or otherwise formatting data into data signals suitable for transmission.

The transmitting device 216 may be configured to electronically transmit data signals to sender institutions 114 that are superimposed or otherwise encoded with funding requests. Funding requests may include at least a primary account number and a payment amount, or may include a payment amount with a plurality of primary account numbers and associated payment amounts for aggregated remittance. The transmitting device 216 may also be configured to electronically transmit data signals superimposed or otherwise encoded with settlement notices to recipient institutions 116. Settlement notices transmitted to recipient institutions 116 may include a recipient account number and a settlement amount, or may include a single settlement amount and a plurality of recipient account numbers and associated settlement amounts for aggregated settlement. The transmitting device 216 may also be configured to electronically transmit data signals to recipient systems 110 and/or recipient networks 118, which may be superimposed or otherwise encoded with at least a settlement amount, and may also include additional data suitable for use by the recipient entity, such as reconciliation data for the related point to point transaction, which may include, for example, an invoice number, purchase order number, line item product data, etc. Transmitting devices 216 may also be configured to transmit data signals to other computing devices 200 in the processing system 102. For example, the transmitting device 216 of the first computing device 104 may transmit a data signal to the second computing device 106 that includes aggregated remittance request data for inclusion in a funding request. Transmitting devices 216 may be further configured to transmit funds to transaction accounts (e.g., associated with recipient institutions 116) or to electronically transmit instructions to initiate fund transfers, using traditional methods and systems.

In some instances transmitting device 216 may be configured to electronically transmit data signals to third party entities that are superimposed or otherwise encoded with a data message for conversion from one standard to another, such as for conversion from the ISO 8583 standard to the ISO 20022 standard. In some embodiments, a transmitting device 216 of a computing device 200 may be configured to transmit data messages that are formatted using a single standard. In some cases, a computing device 200 may include multiple transmitting devices 216, where each transmitting device 216 is configured to transmit data messages formatted using a single, associated standard.

The transmitting device 216 may also be configured to electronically transmit the second data message to a first financial institution associated with a transaction account related to the primary account number. The transmitting device 216 may transmit the third data message to a second financial institution associated with a transaction account related to the recipient account number and transmit the first data message, the second data message, and the third data message for display on a graphical user interface (GUI).

The computing device 200 may also include a memory 218. The memory 218 may be configured to store data for use by the computing device 200 in performing the functions discussed herein. The memory 218 may be configured to store data using suitable data formatting methods and schema and may be any suitable type of memory, such as read-only memory, random access memory, etc. The memory 218 may include, for example, encryption keys and algorithms, communication protocols and standards, data formatting standards and protocols, program code for modules and application programs of the processing device, and other data that may be suitable for use by the computing device 200 in the performance of the functions disclosed herein as will be apparent to persons having skill in the relevant art. In some embodiments, the memory 218 may be comprised of or may otherwise include a relational database that utilizes structured query language for the storage, identification, modifying, updating, accessing, etc. of structured data sets stored therein.

### First Process for Settlement of Point to Point Transactions

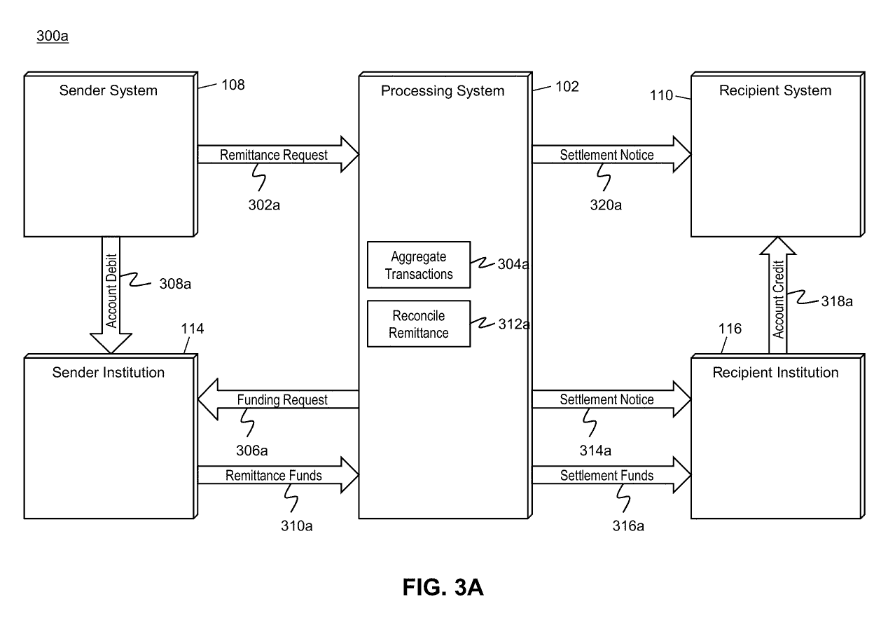

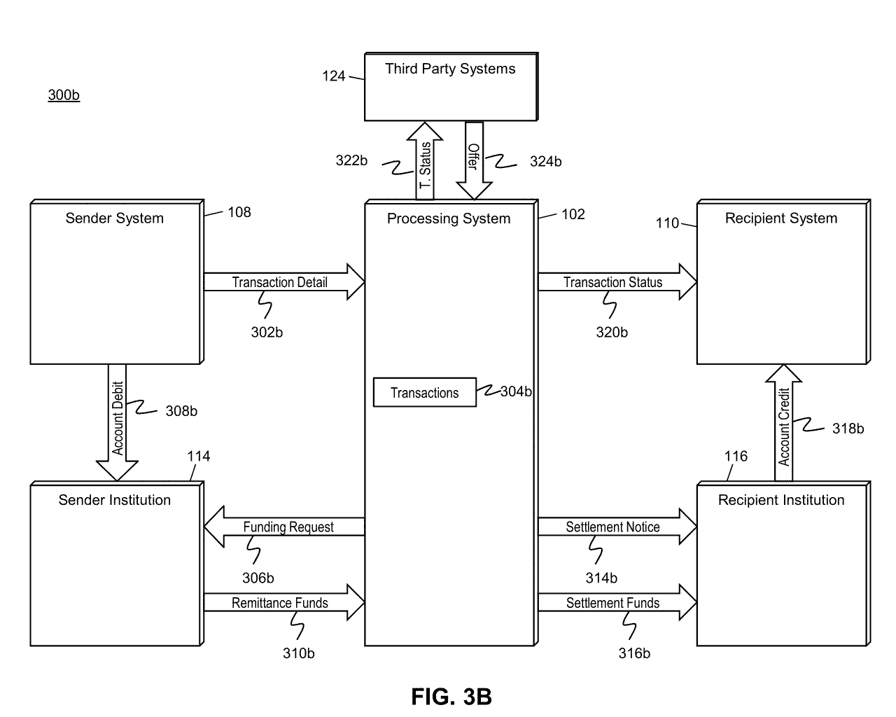

FIG. 3A is a flow diagram illustrating a process 300a for settlement of a point to point transaction using a single computing device and entity systems in accordance with exemplary embodiments. The process 300a for the processing and settlement of a point to point transaction that utilizes the processing system 102 having a single computing device 200, and where the processing system 102 communicates directly with sender systems 108 and recipient systems 110.

In step 302a, the sender system 108 may electronically transmit a data signal to the processing system 102 that is superimposed or otherwise encoded with a remittance request for a point to point transaction. The remittance request may include at least a primary account number associated with a transaction account used to fund the point to point transaction, a transaction amount to be paid in the point to point transaction, and a recipient account number associated with a transaction account used to receive the paid funds. In some embodiments, the remittance request may also include reconciliation data, such as a purchase order number, invoice number, and line item product data. The receiving device 202 of the computing device 200 of the processing system 102 may receive the data signal and parse the remittance request superimposed thereon. In some cases, the remittance request may be formatted pursuant to a standard, such as the ISO 8583 or ISO 20022 standard.

In step 304a, the determination module 214 of the computing device 200 in the processing system 102 may aggregate the received remittance request with the remittance requests received for other point to point payment transactions. Aggregation of the remittance request may include aggregating the transaction amount in the received remittance request with the transaction amounts included in other remittance requests that include the same primary account number, or that include other primary account numbers having the same bank identification number, issuer identification number, or other identifying value associated with a single sender institution 114. In some instances, aggregation performed in step 304a may also include aggregation of the received remittance request with other remittance requests for settlement, where the other remittance requests may include the same recipient account number or other recipient account numbers having the same bank identification number, issuer identification number, or identifying value associated with a single recipient institution 116. As part of the aggregation, the generation module 212 of the computing device 200 in the processing system 102 may generate a funding request, where the funding request includes the payment amount aggregated for the sender institution 114, the primary account number and its associated transaction amount, and the other primary account numbers and corresponding transaction amounts. In some embodiments, the funding request may be formatted pursuant to a standard, such as the ISO 8385 or ISO 20022 standards.

In step 306a, the transmitting device 216 of the computing device 200 in the processing system 102 may electronically transmit a data signal superimposed or otherwise encoded with the funding request to the sender institution 114. In some embodiments, the data signal may be electronically transmitted via payment rails associated with a payment network. In step 308a, the sender institution 114 may debit the transaction account issued to the sender system 108, as associated with the primary account number, for the transaction amount included in the remittance request, as indicated in the funding request received from the processing system 102. In step 310a, the sender institution 114 may transfer remittance funds totaling the aggregated payment amount included in the funding request to the processing system 102 using traditional methods and systems.

In step 312a, the determination module 214 of the computing device 200 in the processing system 102 may perform reconciliation of the remittance. Reconciliation may include associating the received remittance funds with the corresponding remittance requests, which may be based on the received amount and the remittance requests aggregated into the corresponding funding request. Reconciliation may also include determining that the settlement amount aggregated for the recipient institution 116 associated with the recipient account number included in the remittance request received from the sender system 108 has been received from the various sender institutions 114.

Once a suitable amount of funds have been received for the recipient institution's settlement, the generation module 212 of the computing device 200 in the processing system 102 may generate a settlement notice that includes the aggregated settlement amount, the recipient account number and transaction amount from the remittance request, and the other recipient account numbers and associated transaction amounts from the corresponding aggregated remittance requests. In some embodiments, the settlement notice may be formatted pursuant to a standard, such as the ISO 8385 or ISO 20022 standards. In step 314a, the transmitting device 216 of the computing device 200 in the processing system 102 may electronically transmit a data signal superimposed or otherwise encoded with the settlement notice to the recipient institution 116. In some instances, the data signal may be transmitted via payment rails associated with a payment network. In step 316a, the transmitting device 216 may transfer or initiate the transfer of funds corresponding to the aggregated settlement amount to the recipient institution 116 using traditional methods.

In step 318a, the recipient institution 116 may credit the transaction account issued to the recipient entity that is associated with the recipient account number included in the remittance request with the transaction amount. The recipient institution 116 may also credit the other transaction accounts associated with the other recipient account numbers included in the settlement notice with the associated transaction amounts. As part of the reconciliation performed in step 312a, the generation module 212 of the computing device 200 in the processing system 102 may also generate a settlement notice for the recipient system 110. The settlement notice may include at least the transaction amount, and may also include reconciliation data included in the remittance request, if applicable, and any other data suitable for providing to the recipient system 110. The settlement notice may be formatted pursuant to a standard, such as the ISO 8583 or ISO 20022 standards. In step 320a, the transmitting device 216 may electronically transmit a data signal to the recipient system 110 that is superimposed or otherwise encoded with the settlement notice.

FIG. 3B is a flow diagram illustrating a process 300b for recording, processing, and displaying of point to point transactions using a single computing device and entity systems in accordance with exemplary embodiments. The process 300b for recording, processing, and displaying of point to point transactions utilizes the processing system 102 having a single computing device 200, and where the processing system 102 communicates directly with sender systems 108 and recipient systems 110.

In step 302b, the sender system 108 may electronically transmit a data signal to the processing system 102 that is superimposed or otherwise encoded with a transaction detail for a point to point transaction. The transaction detail may include at least a primary account number associated with a transaction account used to fund the point to point transaction, a transaction amount to be paid in the point to point transaction, and a recipient account number associated with a transaction account used to receive the paid funds. In some embodiments, the transaction detail may also include reconciliation data, such as a purchase order number, invoice number, and line item product data. The receiving device 202 of the computing device 200 of the processing system 102 may receive the data signal and parse the remittance request superimposed thereon. In some cases, the transaction detail may be formatted pursuant to a standard, such as the ISO 8583 or ISO 20022 standard.

In step 304b, the computing device 200 in the processing system 102 may store the received transaction details for that payment transaction and the transaction details received for other point to point payment transactions. In step 306b, the transmitting device 216 of the computing device 200 in the processing system 102 may electronically transmit a data signal superimposed or otherwise encoded with the funding request to the sender institution 114. In some embodiments, the data signal may be electronically transmitted via payment rails associated with a payment network. In step 308b, the sender institution 114 may debit the transaction account issued to the sender system 108, as associated with the primary account number, for the transaction amount included in the transaction detail, as indicated in the funding request received from the processing system 102. In step 310b, the sender institution 114 may transfer funds totaling the payment amount included in the funding request to the processing system 102 using traditional methods and systems.

In some implementations, a third party system 124 may be made aware of the transaction details. The third party system 124 may be, for example, a company interested in providing funds for the recipient entity to borrow based on the expected settlement. The recipient entity may opt-in with the processing system 102 to allow the third party system 104 to view the ledger with respect to their payment transactions. In step 322b, the third party system 124 may access a view of the trade directory with respect to the payment transaction being settled and additional transactions stored in the ledger associated with the recipient entity.

In step 324b, the third party system 124 may provide the ability for the recipient entity to get on-demand cash by providing them an offer associated with the payment transaction being settled. The third party system 124 may review the transaction history of the recipient entity, which may include identifying prior transactions between the recipient entity and the specific sender entity paying the remittance for the transaction, and determine an interest rate for providing a loan based on the transaction. The offer may be communicated to the recipient entity directly or via the processing system 102, which may be accepted or declined by the recipient entity. If accepted, the third party system 124 may provide the early payment to the recipient entity for later repayment, which may be made directly by the recipient entity, or via the processing system 102 and/or recipient institution 116 as part of the settlement process discussed herein.

In step 314b, the transmitting device 216 of the computing device 200 in the processing system 102 may electronically transmit a data signal superimposed or otherwise encoded with the settlement notice to the recipient institution 116. In some instances, the data signal may be transmitted via payment rails associated with a payment network. In step 316b, the transmitting device 216 may transfer or initiate the transfer of funds corresponding to the aggregated settlement amount to the recipient institution 116 using traditional methods.

In step 318b, the recipient institution 116 may credit the transaction account issued to the recipient entity that is associated with the recipient account number included in the remittance request with the transaction amount. The recipient institution 116 may also credit the other transaction accounts associated with the other recipient account numbers included in the settlement notice with the associated transaction amounts. In instances where the recipient entity accepted the offer of the third party system 124, the recipient institution 116 may provide payment in the credit amount to the third party system 124. In some such instances, the recipient institution 116 may credit the transaction account as normal, where the recipient entity may repay the loan with the third party system 124 on its own. In step 320b, the transmitting device 216 may electronically transmit a data signal to the recipient system 110 that is superimposed or otherwise encoded with the transaction status so that the recipient can view the ledger detailing the transaction details. The recipient entity may then finalize the transaction with the third party system 124 by repaying the loan according to the established terms.

### Second Process for Settlement of Point to Point Transactions

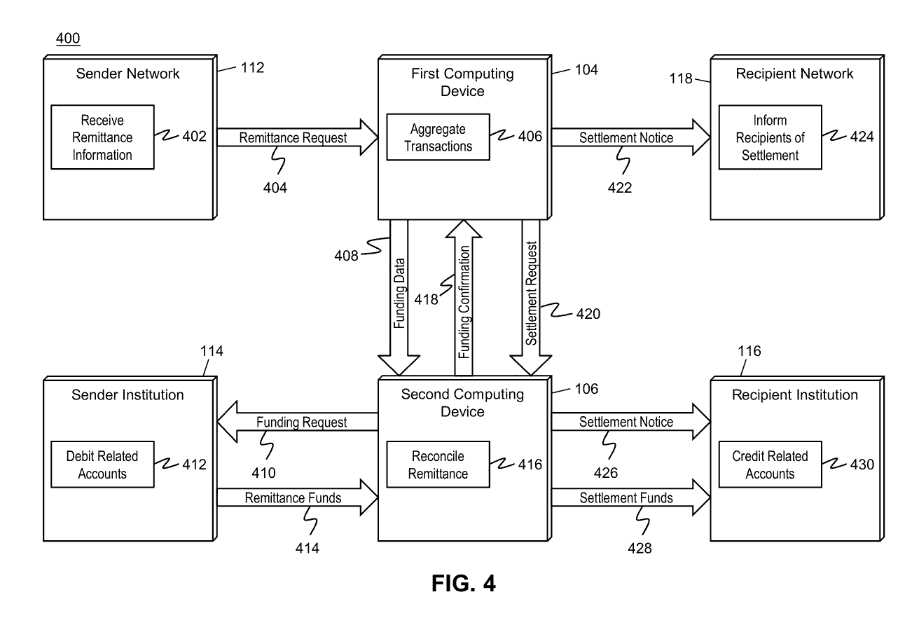

FIG. 4 illustrates an alternative process 400 for the processing and settlement of a point to point transaction that utilizes the processing system 102 using the first computing device 104 and the second computing device 106, and where the processing system 102 communicates directly with sending entities and recipient entities via the sender network 112 and recipient network 118, respectively. In some instances, the sender network 112 and recipient network 118 may be the same entity.

In step 402, the sender network 112 may receive remittance information from a sending entity. In some instances, the remittance information may be received from a sender system 108, such as via an electronic transmission therefrom. In other instances, the remittance information may be received via communication with a computing device used by the sending entity, such as via a web page or application program. In some cases, remittance information may be manually entered by a user of the sender network 112, such as an employee of the sender network 112 manually inputting data in the sender network 112 based on instructions received from the sending entity. The remittance information provided to the sender network 112 may include the primary account number for the transaction account issued to the sending entity by the sender institution 114, the transaction amount to be paid, and the recipient account number for the transaction account issued to the recipient entity by a recipient institution 116 for receipt of the payment.

In step 404, the sender network 112 may electronically transmit a data signal to the first computing device 104 of the processing system 102 that is superimposed or otherwise encoded with a remittance request. The remittance request may include at least the primary account number, transaction amount, and recipient account number. In some embodiments, the remittance request may be formatted pursuant to the ISO 8583 standard. In step 406, the determination module 214 of the first computing device 104 may aggregate the remittance request with associated remittance requests. The aggregation may include an aggregation for remittance for the point to point transaction, and an aggregation for settlement for the point to point transaction. Aggregation for remittance may include aggregating the remittance request with other remittance requests that include the same primary account number or other primary account numbers where each includes a common identifying value associated with the sender institution 114. Aggregation for settlement may include aggregating the remittance request with other remittance requests that include the same recipient account number or other recipient account numbers where each includes a common identifying value associated with the recipient institution 116.

In step 408, the transmitting device 216 of the first computing device 104 may electronically transmit funding data associated with the sender institution 114 to the second computing device 106 of the processing system 102 using internal communication methods and networks. The receiving device 202 of the second computing device 104 may receive the funding data, which may include at least the transaction amount and primary account number included in the received remittance request and the identified aggregated remittance requests. In some instances, the funding data may also include the aggregated payment amount. In other instances, the determination module 214 of the second computing device 106 may determine the aggregated payment amount.

The generation module 212 of the second computing device 106 may generate a funding request, where the funding request includes at least the aggregated payment amount, each of the primary account numbers, and the associated transaction amounts. In some embodiments, the funding request may be formatted pursuant to the ISO 20022 standard. In step 410, the transmitting device 216 of the second computing device 106 may electronically transmit a data signal superimposed or otherwise encoded with the funding request to the sender institution 114. In step 412, the sender institution 114 may debit the transaction accounts corresponding to each of the primary account numbers included in the funding request by their associated transaction amount. In step 414, the sender institution 114 may initiate the transfer of remittance funds in the amount of the aggregated payment amount to the processing system 102.

In step 416, the determination module 214 of the second computing device 106 may perform reconciliation of the received remittance funds. Reconciliation may include the association of the remittance funds with the received funding data to determine which remittance requests have been funded. As part of the reconciliation, in step 418, the transmitting device 216 of the second computing device 106 may electronically transmit confirmation of receipt of the remittance funds to the first computing device 104 using internal communication networks and methods. In some embodiments, the second computing device 106 may only confirm the receipt of the remittance funds, with additional reconciliation being performed by the determination module 214 of the first computing device 104. Reconciliation may include determining if a suitable amount of the settlement amount aggregated for the recipient institution 116 (e.g., as performed in step 406) has been received.

Once suitable amount has been received, then, in step 420, the transmitting device 216 of the first computing device 104 may electronically transmit a data signal to the second computing device 106 using internal communication networks and methods that is superimposed or otherwise encoded with a request to perform settlement. The settlement request may include at least the recipient account numbers and transaction amounts aggregated for the recipient institution 116. In some embodiments, the settlement request may also include the aggregated settlement amount. In other embodiments, the determination module 214 of the second computing device 106 may determine the aggregated settlement amount.

When requesting the settlement, the first computing device 104 may (e.g., via the generation module 212 included therein) generate a settlement notice for distribution to the recipient entity. The settlement notice may include at least the transaction amount included in the received remittance request, and may include any additional data, such as reconciliation data. In some embodiments, the settlement notice may be formatted pursuant to the ISO 8583 standard. In step 422, the transmitting device 216 of the first computing device 104 may electronically transmit a data signal to the recipient network 118 that is superimposed or otherwise encoded with the settlement notice. In step 424, the recipient network 118 may inform the recipient entity that the settlement funds were received. The recipient network 118 may communicate with the recipient entity via any suitable method, such as telephone, email, short messaging service, multimedia messaging service, etc.

After receiving the settlement request from the first computing device 104, the generation module 212 of the second computing device 106 may generate a settlement notice for distribution to the recipient institution 116. The settlement notice may include at least each of the recipient account numbers from the aggregated remittance requests and the associated transaction amounts. In some cases, the settlement notice may also include the aggregated settlement amount. In some embodiments, the settlement notice may be formatted pursuant to the ISO 20022 standard. In step 426, the transmitting device 216 of the second computing device 106 may electronically transmit a data signal superimposed or otherwise encoded with the settlement notice to the recipient institution 116. In step 428, the processing system 102 may initiate the transfer the aggregated settlement amount to the recipient institution 116. In step 430, the recipient institution may credit each of the transaction accounts corresponding to the recipient account numbers with the associated transaction amount.

### Processing of Aggregated Settlement for Point to Point Transactions

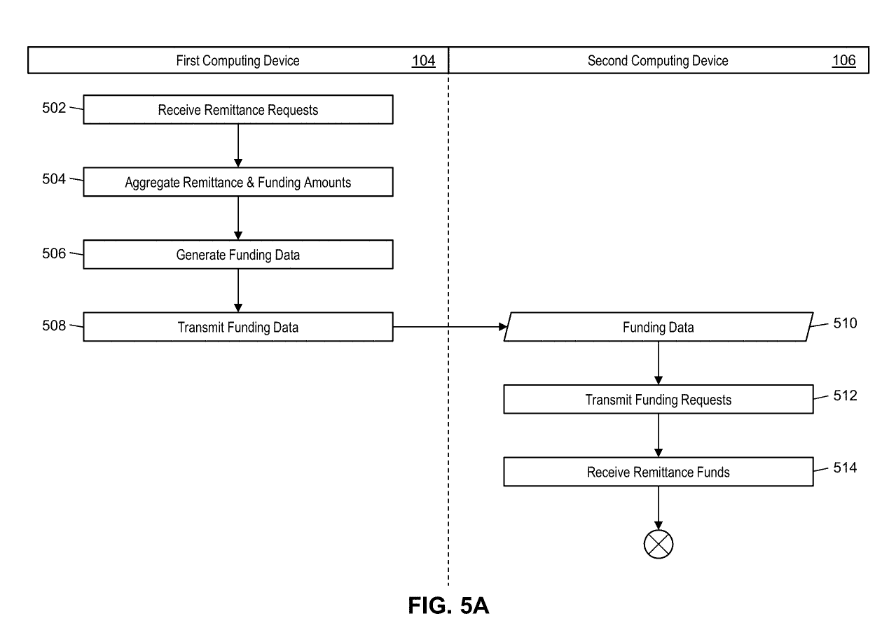

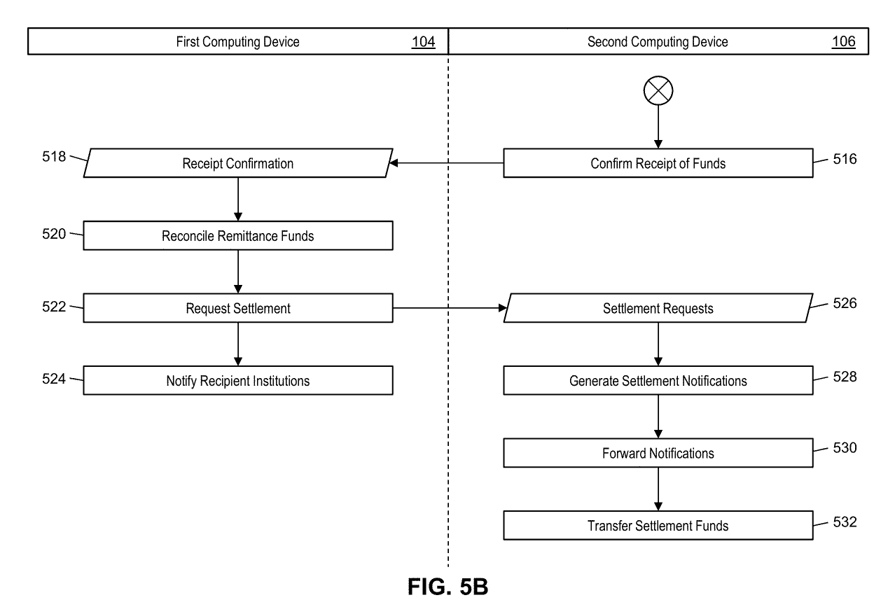

FIGS. 5A and 5B are flow diagrams illustrating a process for the settlement of a point to point transaction using multiple computing devices in the processing system of FIG. 1 in accordance with exemplary embodiments. FIGS. 5A and 5B illustrate a process for the settlement of aggregated point to point transactions using multiple computing devices 200 in the processing system 102, where the point to point transactions are aggregated for both remittance and settlement. It will be apparent to persons having skill in the relevant art that the functions discussed herein as performed by the processing system 102 illustrated in FIGS. 5A and 5B may be alternative performed using a single computing device 200 and may include aggregation of only remittance or only settlement as an alternative to the process illustrated in FIGS. 5A and 5B.

In step 502, the receiving device 202 of the first computing device 104 may receive a plurality of remittance requests. Remittance requests may be received from sender systems 108, sender networks 112, and/or sender institutions 114. Each remittance request may include at least a primary account number associated with the transaction account from which payment is to be made, the transaction amount for the payment, and a recipient account number associated with the transaction account to receive the payment. In some embodiments, a remittance request may also include reconciliation data. In some instances, remittance requests may be formatted pursuant to the ISO 8583 or ISO 20022 standards.

In step 504, the determination module 214 of the first computing device 104 may aggregate remittance amounts and funding amounts for the plurality of remittance requests. Remittance amounts may be an amount for each sender institution 114 that is associated with at least one primary account number included in the received remittance requests, where the respective remittance amount may be a summation of the transaction amount included in each remittance request that includes a primary account number associated with the sender institution 114, which may be determined based on a bank identification number, issuer identification number, or other identifying value included in the primary account number. Funding amounts may be an amount for each recipient institution 116 that is associated with at least one recipient account number included in the received remittance requests, where the respective funding amount may be a summation of the transaction amount included in each remittance request that includes a primary account number associated with the recipient institution 116, which may be determined based on a bank identification number, issuer identification number, or other identifying value included in the recipient account number.

In step 506, the generation module 212 of the first computing device 104 may generate funding data. The funding data may include the determined remittance amount for each sender institution 114, the corresponding sender institution 114, and, for each sender institution 114, the associated primary account numbers and corresponding transaction amounts. In step 508, the transmitting device 216 of the first computing device 104 may electronically transmit a data signal superimposed or otherwise encoded with the funding data to the second computing device 106 via internal communication networks and methods of the processing system 102. In step 510, the receiving device 202 of the second computing device 106 may receive the funding data.

In step 512, the generation module 212 of the second computing device 106 may generate a funding request for each sender institution 114, with the funding request including the associated remittance amount and associated primary account numbers with their corresponding transaction amounts, which may be superimposed or otherwise encoded in a data signal electronically transmitted to the respective sender institution 114 by the transmitting device 216 of the second computing device 106. In some embodiments, each funding request may be formatted pursuant to the ISO 8583 or ISO 20022 standards. The sender institutions 114 may receive the funding requests and may process them accordingly with the remittance amounts being provided to the processing system 102. In step 514, the receiving device 202 of the second computing device 106 may receive the remittance funds from the sender institutions 114 or confirmation thereof.

In step 516, the transmitting device 216 of the second computing device 106 may electronically transmit a data signal to the first computing device 104 using internal communication methods and networks of the processing system 102 that is superimposed with a confirmation of the receipt of remittance funds. The confirmation may include at least the sender institutions 114 from which funds were received and the corresponding remittance amounts that were received. In step 518, the receiving device 202 of the first computing device 104 may receive the confirmation. In step 520, the determination module 214 of the first computing device 104 may perform reconciliation of the remittance funds, which may include determining which remittance requests the received funds correspond to, which may be used to determine if suitable funds have been received for settlement with any of the recipient institutions 116.

In step 522, the generation module 212 of the first computing device 104 may generate a settlement request, which may include the funding amount for each recipient institution 116 that is to receive settlement (e.g., based on reconciliation) as well as the associated recipient account numbers and corresponding transaction amounts, and may electronically transmit (e.g., via the transmitting device 216 of the first computing device 104) the settlement request to the second computing device 106 using suitable internal communication networks and methods of the processing system 102. In some embodiments, the settlement request may be formatted pursuant to the ISO 8583 or ISO 20022 standards. In step 524, the generation module 212 of the first computing device 104 may generate a settlement notice for each of the plurality of remittance requests, which may include at least the transaction amount and any other additional data (e.g., reconciliation data included in the remittance request), which may be superimposed or otherwise encoded in a data signal electronically transmitted to an associated recipient system 110, recipient institution 116, or recipient network 118 for notification to the recipient entity of the settlement of the point to point transaction.

In step 526, the receiving device 202 of the second computing device 106 may receive the settlement request from the first computing device 104. In step 528, the generation module 212 of the second computing device 106 may generate a settlement notification for each of the recipient institutions 116. Each settlement notification may include the aggregated funding amount determined for the recipient institution 116, the associated recipient account numbers from the remittance requests, and their corresponding transaction amounts. In some embodiments, the settlement notifications may be formatted pursuant to the ISO 8583 or ISO 20022 standards. In step 530, the transmitting device 216 of the second computing device 106 may electronically transmit a data signal to each recipient institution 116 that is superimposed or otherwise encoded with the associated settlement notification. In step 532, the transmitting device 216 may transfer or initiate the transfer of the settlement funds to each of the recipient institutions 116 using traditional methods and systems.

### Process for Recording and Display of Point to Point Transactions

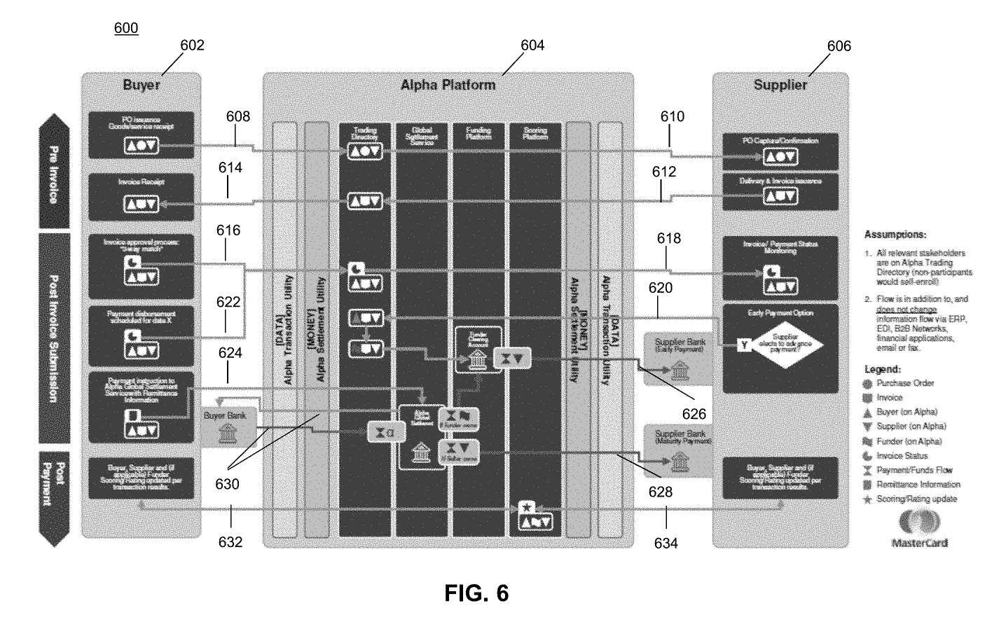

FIG. 6 is a diagram illustrating a process 600 for recording, processing, and displaying of point to point transactions in the processing system of FIG. 1 in accordance with exemplary embodiments. For example, the process 600 illustrates providing the ability of companies to pay their supplies or vendors by way of a non-card payment, because when a supplier sending bills to its customers, typically the supplier is not accepting payments on a credit card.

In step 608, the buyer 602 (e.g., sender entity) may issue a purchase order for a good and/or service which may be sent to the system platform 604. The system platform 604 may be a platform provided by the processing system 102 and implemented via the computing devices 200 included therein, such as the first computing device 104 and second computing device 106. In step 610, the system platform 604 may transmit this data as a transaction detail to the supplier 606 (e.g., recipient entity), which will confirm the receipt of the purchase order.

In some implementations, the system platform 604 may use APIs to capture the important transaction data (e.g., transaction amount, name of requested goods and/or services, quantity of requested goods and/or services, payment date, etc.) and store the information in an internal database (e.g., account database 206) in a ledger along with account profile information in a trade directory of the buyer 602 and the supplier 606. The system platform 604 may provide a link to the original purchase order, invoice, and/or any other correspondence related to the transaction. The link will show the original correspondence back on the website and/or payment processing system of the buyer 602, the supplier 606, and/or any other system.

In step 612, the supplier 606 may send an invoice to the system platform 604. The system platform 604, using an API, will extract the important information, and send the data to the buyer 602 in step 614. For example, the supplier 606 may send an invoice to the buyer 602 in order to pay the supplier 606 on 30 or 60 days terms, etc. Most suppliers would hope to receive the funds within 30 days and hope they are paid in 30 days. However, in prior art systems, most suppliers do not have visibility of the payment posting and how the payment is actually made, which can lead to cash flow problem. The system platform 604 avoids these problems by providing a platform where transaction visibility and ensuing expectation of timely payment is clear to all parties involved. The system platform 604 provides a trade directory which captures the identity of the parties and a ledger of all the transactions that exist. The identity of the parties (i.e., the payor and payee, or buyer and supplier) also includes the party information, the corporate identity, and the individuals within that firm that have authority over banking and financial transactions and/or actual bank account information. The trade directory is a ledger of all the transactions that exist between the identified parties on the utilizing the system platform.

In step 616, the buyer 602 approves the invoice. In step 618, the supplier 606 monitors the invoice and the payment status. For example, the supplier 606 can sign up to use the system by registering in the trade directory, where their bank account information is in the system, whoever is responsible for Accounts Payable (AP) or Accounts Receivable (AR) as well as their financial and treasury officers are identified, the authorized individuals for supplier's financial transactions and any purchase orders are identified, and invoices and payments that are made via the system platform are captured in the ledger aspect of this trade directory. As a result, over time, every purchase order, invoice, transaction between the enabled parties, or statuses thereof and timely performance thereto, are captured in the ledger.

In step 620, the supplier may elect to a payment in advance. The system platform 604 may comprise of one or more third party systems, which provide funds to borrow, or sell a receivable on a non-recourse basis, depending on the terms offered by a third party financial provider, at an interest rate. The visibility into the data provided by the system platform 604 provides an opportunity to third party systems. For example, a supplier 606 may opt in to allow third party systems to view the ledger with respect to the supplier's transactions. The third-party systems may access a view of the trade directory that is compliant with privacy concerns and with the consent of all parties involved in the transaction. The third party systems may analyze the price risk and offer financial solutions to, for example, the supplier 606 for a particular invoice. The third party system may provide the ability for the supplier 606 to get on-demand cash. Thus, instead of waiting until day 30 or day 40 for the supplier 606 to receive their cash, based on the history of transactions between the supplier 606 and the buyer 602, the third party system may see that the buyer 602 pays 99.9 percent of their invoices in full and so the third party system may have a high degree of comfort based on the data from the ledger that the buyer 602 will pay the next invoice of that supplier 606. The third party system may then offer a very low APR to that supplier 606 to advance cash.

In step 622, the payment disbursement date is scheduled by the buyer 602. In step 624, the payment instruction to the system platform 604 with remittance information is provided. In step 628, the supplier bank has received an early payment. In step 630, the buyer bank provides a payment to the system platform 604. In steps 632 and 634, the buyer 602, supplier 606, and third party data based on the transaction results is uploaded into the system platform 604 as part of the ledger.

### Exemplary Method for Processing a Point to Point Payment Transaction

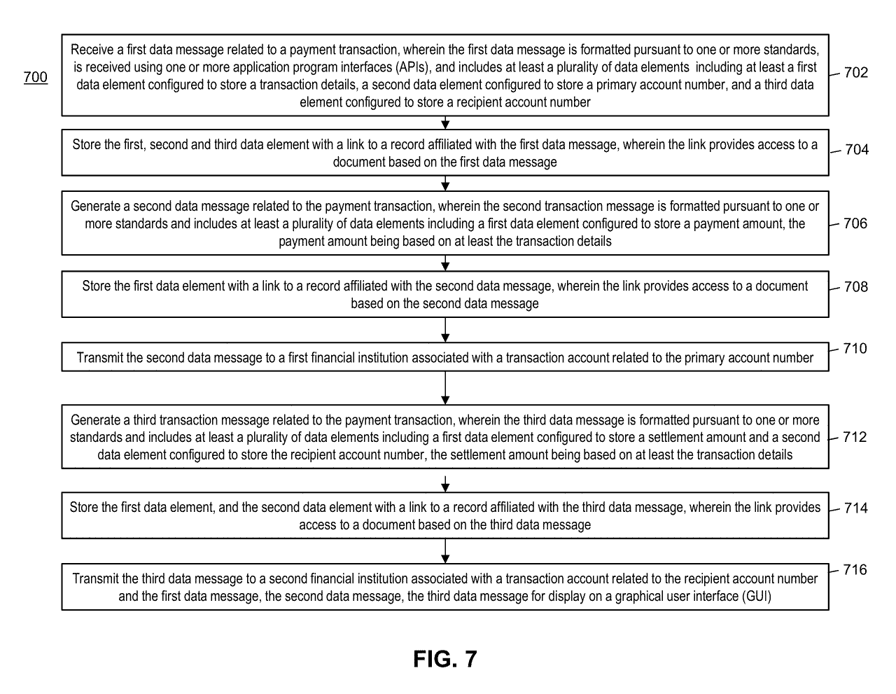

FIG. 7 is a flowchart illustrating an exemplary method for processing a point to point payment transaction in accordance with exemplary embodiments.

In step 702, a first data message related to a payment transaction may be received by a receiving device (e.g., the receiving device 202) of a processing server (e.g., the processing server 102), wherein the first data message is formatted pursuant to one or more standards, is received using one or more application program interfaces (APIs), and includes at least a plurality of data elements including at least a first data element configured to store a transaction details, a second data element configured to store a primary account number, and a third data element configured to store a recipient account number.

In step 704, the first, second, and third data element may be stored in a commerce database (e.g., database 122) of the processing server (e.g., the processing server 102) with a link to a record affiliated with the first data message, wherein the link provides access to a document based on the first data message.

In step 706, the second data message related to the payment transaction may be generated by a generation module (e.g., the generation module 212) of the processing server (e.g., the processing server 102), wherein the second data message is formatted pursuant to one or more standards and includes at least a plurality of data elements including a first data element configured to store a payment amount, the payment amount being based on at least the transaction details. In step 608, the first data element with a link to a record affiliated with the second data message may be stored in the commerce database (e.g., database 122) of the processing server (e.g., processing server 102), wherein the link provides access to a document based on the second data message.

In step 710, the second data message may be electronically transmitted, by a transmitting device (e.g., transmitting device 216) of the processing server (e.g., 102), to a first financial institution associated with a transaction account related to the primary account number. In step 712, a third data message related to the payment transaction may be generated by the generation module (e.g., generation module 212) of the processing server (e.g., processing server 102), wherein the third data message is formatted pursuant to one or more standards and includes at least a plurality of data elements including a first data element configured to store a settlement amount and a second data element configured to store the recipient account number, the settlement amount being based on at least the transaction details.

In step 112, the first data element and the second data element may be stored in the commerce database (e.g., database 122) of the processing server (e.g., 102), with a link to a record affiliated with the third data message, wherein the link provides access to a document based on the third data message.

In step 114, the third data message may be electronically transmitted by the transmitting device (e.g., transmitting device 216) of the processing server (e.g., processing server 102) to a second financial institution associated with a transaction account related to the recipient account number and the first data message, the second data message, the third data message may be transmitted for display on a graphical user interface (GUI).

In one embodiment, the first data message, second data message, and third data message may be transaction messages formatted pursuant to the ISO 8583 standard. In another embodiment, the first data message may be formatted pursuant to the ISO 8583 standard, and the second data message and third data message may be formatted pursuant to the ISO 20022 standard. In a further embodiment, generating the second data message may include converting the first data message to the second data message based on correspondences between the ISO 8583 standard and the ISO 20022 standard. In some embodiments, the payment amount may be equivalent to the transaction amount, and/or the settlement amount may be equivalent to the transaction amount.

In one embodiment, the method 100 may further include: receiving, by the receiving device of the processing server, one or more additional data messages, wherein each additional data message is related to an additional payment transaction and includes a plurality of data elements including at least a first data element configured to store one of a plurality of account numbers and a second data element configured to store a different transaction amount, wherein the payment amount is an aggregation of the different transaction amount stored in the second data element included in each additional data message, and the primary account number and each of the plurality of account numbers includes a common bank identification number or issuer identification number. In a further embodiment, the primary account number and each of the plurality of account numbers may be associated with the same transaction account. In another further embodiment, the common bank identification number or issuer identification number may be associated with the first financial institution.

In one embodiment, the transaction details comprise one or more of: a transaction amount, order date, fulfillment date, and status. The settlement amount may be equivalent to the transaction details. In some implementations, the data elements stored in the commerce database comprise of a trade directory and/or a ledger.

In some embodiments, the method 100 may also include: receiving, by the receiving device of the processing server, one or more additional data messages, wherein each additional data message is related to an additional payment transaction and includes a plurality of data elements including at least a second data element configured to store a different transaction amount and a third data element configured to store one of a plurality of account numbers, wherein the settlement amount is an aggregation of the different transaction amount stored in the second data element included in each additional data message, and the recipient account number and each of the plurality of account numbers includes a common bank identification number or issuer identification number. In a further embodiment, the recipient account number and each of the plurality of account numbers may be associated with the same transaction account. In another further embodiment, the common bank identification number or issuer identification number may be associated with the second financial institution.

In one embodiment, the method 100 may further include: generating, by a generation module of the processing server, a fourth data message related to the payment transaction, wherein the fourth data message is formatted pursuant to a standard and includes a plurality of data elements including at least a first data element configured to store the transaction amount and a second data element configured to store the recipient account number; and electronically transmitting, by a transmitting device of the processing server, the fourth data message. In a further embodiment, the fourth data message may be electronically transmitted to the second financial institution. In another further embodiment, the first data message may be received from and the fourth data message may be electronically transmitted to a third party system. In yet another further embodiment, the fourth data message may be formatted pursuant to the ISO 8583 standard.

In some embodiments, the processing server may include a first computing device (e.g., the first computing device 104) and a second computing device (e.g., the second computing device 106), where the first computing device includes the receiving device and the second computing device includes the generation module, determination module, and the transmitting device. In a further embodiment, the method 600 may further include generating, by a generation module of the first computing device of the processing server, a data signal superimposed with at least the payment amount; electronically transmitting, by a transmitting device of the first computing device of the processing server, the generated data signal to the second computing device; and receiving, by a receiving device of the second computing device of the processing server, the data signal.

### Payment Transaction Processing System and Process

FIG. 8 is a flow diagram illustrating the processing of a payment transaction in accordance with exemplary embodiments.

FIG. 8 illustrates a transaction processing system and a process 800 for the processing of payment transactions in the system, which may include the processing of thousands, millions, or even billions of transactions during a given period (e.g., hourly, daily, weekly, etc.). The process 800 and steps included therein may be performed by one or more components of the system 100 discussed above, such as the processing system 102, sender institution 114, recipient institution 116, etc. The processing of payment transactions using the system and process 800 illustrated in FIG. 8 and discussed below may utilize the payment rails, which may be comprised of the computing devices and infrastructure utilized to perform the steps of the process 800 as specially configured and programmed by the entities discussed below, including the transaction processing server 812, which may be associated with one or more payment networks configured to processing payment transactions. It will be apparent to persons having skill in the relevant art that the process 800 may be incorporated into the processes illustrated in FIGS. 3A, 3B, 4, 5A, 5B, 6, and 7 discussed above, with respect to the step or steps involved in the processing of a payment transaction. In addition, the entities discussed herein for performing the process 800 may include one or more computing devices or systems configured to perform the functions discussed below. For instance, the merchant 806 may be comprised of one or more point of sale devices, a local communication network, a computing server, and other devices configured to perform the functions discussed below.

In step 820, an issuing financial institution 802 may issue a payment card or other suitable payment instrument to a consumer 804. The issuing financial institution may be a financial institution, such as a bank, or other suitable type of entity that administers and manages payment accounts and/or payment instruments for use with payment accounts that can be used to fund payment transactions. The consumer 804 may have a transaction account with the issuing financial institution 802 for which the issued payment card is associated, such that, when used in a payment transaction, the payment transaction is funded by the associated transaction account. In some embodiments, the payment card may be issued to the consumer 804 physically. In other embodiments, the payment card may be a virtual payment card or otherwise provisioned to the consumer 804 in an electronic format.

In step 822, the consumer 804 may present the issued payment card to a merchant 806 for use in funding a payment transaction. The merchant 806 may be a business, another consumer, or any entity that may engage in a payment transaction with the consumer 804. The payment card may be presented by the consumer 804 via providing the physical card to the merchant 806, electronically transmitting (e.g., via near field communication, wireless transmission, or other suitable electronic transmission type and protocol) payment details for the payment card, or initiating transmission of payment details to the merchant 806 via a third party. The merchant 806 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 824, the merchant 806 may enter transaction details into a point of sale computing system. The transaction details may include the payment details provided by the consumer 804 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 806 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 806 may be an online retailer in an e-commerce transaction. In such embodiments, the transaction details may be entered in a shopping cart or other repository for storing transaction data in an electronic transaction as will be apparent to persons having skill in the relevant art.

In step 826, the merchant 806 may electronically transmit a data signal superimposed with transaction data to a gateway processor 808. The gateway processor 808 may be an entity configured to receive transaction details from a merchant 806 for formatting and transmission to an acquiring financial institution 810. In some instances, a gateway processor 808 may be associated with a plurality of merchants 806 and a plurality of acquiring financial institutions 810. In such instances, the gateway processor 808 may receive transaction details for a plurality of different transactions involving various merchants, which may be forwarded on to appropriate acquiring financial institutions 810. By having relationships with multiple acquiring financial institutions 810 and having the requisite infrastructure to communicate with financial institutions using the payment rails, such as using application programming interfaces associated with the gateway processor 808 or financial institutions used for the submission, receipt, and retrieval of data, a gateway processor 808 may act as an intermediary for a merchant 806 to be able to conduct payment transactions via a single communication channel and format with the gateway processor 808, without having to maintain relationships with multiple acquiring financial institutions 810 and payment processors and the hardware associated thereto. Acquiring financial institutions 810 may be financial institutions, such as banks, or other entities that administers and manages payment accounts and/or payment instruments for use with payment accounts. In some instances, acquiring financial institutions 810 may manage transaction accounts for merchants 806. In some cases, a single financial institution may operate as both an issuing financial institution 802 and an acquiring financial institution 810.

The data signal transmitted from the merchant 806 to the gateway processor 808 may be superimposed with the transaction details for the payment transaction, which may be formatted based on one or more standards. In some embodiments, the standards may be set forth by the gateway processor 808, which may use a unique, proprietary format for the transmission of transaction data to/from the gateway processor 808. In other embodiments, a public standard may be used, such as the International Organization for Standardization's ISO 8883 standard. The standard may indicate the types of data that may be included, the formatting of the data, how the data is to be stored and transmitted, and other criteria for the transmission of the transaction data to the gateway processor 808.

In step 828, the gateway processor 808 may parse the transaction data signal to obtain the transaction data superimposed thereon and may format the transaction data as necessary. The formatting of the transaction data may be performed by the gateway processor 808 based on the proprietary standards of the gateway processor 808 or an acquiring financial institution 810 associated with the payment transaction. The proprietary standards may specify the type of data included in the transaction data and the format for storage and transmission of the data. The acquiring financial institution 810 may be identified by the gateway processor 808 using the transaction data, such as by parsing the transaction data (e.g., deconstructing into data elements) to obtain an account identifier included therein associated with the acquiring financial institution 810. In some instances, the gateway processor 808 may then format the transaction data based on the identified acquiring financial institution 810, such as to comply with standards of formatting specified by the acquiring financial institution 810. In some embodiments, the identified acquiring financial institution 810 may be associated with the merchant 806 involved in the payment transaction, and, in some cases, may manage a transaction account associated with the merchant 806.

In step 830, the gateway processor 808 may electronically transmit a data signal superimposed with the formatted transaction data to the identified acquiring financial institution 810. The acquiring financial institution 810 may receive the data signal and parse the signal to obtain the formatted transaction data superimposed thereon. In step 832, the acquiring financial institution may generate an authorization request for the payment transaction based on the formatted transaction data. The authorization request may be a specially formatted transaction message that is formatted pursuant to one or more standards, such as the ISO 8883 standard and standards set forth by a payment processor used to process the payment transaction, such as a payment network. The authorization request may be a transaction message that includes a message type indicator indicative of an authorization request, which may indicate that the merchant 806 involved in the payment transaction is requesting payment or a promise of payment from the issuing financial institution 802 for the transaction. The authorization request may include a plurality of data elements, each data element being configured to store data as set forth in the associated standards, such as for storing an account number, application cryptogram, transaction amount, issuing financial institution 802 information, etc.

In step 834, the acquiring financial institution 810 may electronically transmit the authorization request to a transaction processing server 812 for processing. The transaction processing server 812 may be comprised of one or more computing devices as part of a payment network configured to process payment transactions. In some embodiments, the authorization request may be transmitted by a transaction processor at the acquiring financial institution 810 or other entity associated with the acquiring financial institution. The transaction processor may be one or more computing devices that include a plurality of communication channels for communication with the transaction processing server 812 for the transmission of transaction messages and other data to and from the transaction processing server 812. In some embodiments, the payment network associated with the transaction processing server 812 may own or operate each transaction processor such that the payment network may maintain control over the communication of transaction messages to and from the transaction processing server 812 for network and informational security.

In step 836, the transaction processing server 812 may perform value-added services for the payment transaction. Value-added services may be services specified by the issuing financial institution 802 that may provide additional value to the issuing financial institution 802 or the consumer 804 in the processing of payment transactions. Value-added services may include, for example, fraud scoring, transaction or account controls, account number mapping, offer redemption, loyalty processing, etc. For instance, when the transaction processing server 812 receives the transaction, a fraud score for the transaction may be calculated based on the data included therein and one or more fraud scoring algorithms and/or engines. In some instances, the transaction processing server 812 may first identify the issuing financial institution 802 associated with the transaction, and then identify any services indicated by the issuing financial institution 802 to be performed. The issuing financial institution 802 may be identified, for example, by data included in a specific data element included in the authorization request, such as an issuer identification number. In another example, the issuing financial institution 802 may be identified by the primary account number stored in the authorization request, such as by using a portion of the primary account number (e.g., a bank identification number) for identification.

In step 838, the transaction processing server 812 may electronically transmit the authorization request to the issuing financial institution 802. In some instances, the authorization request may be modified, or additional data included in or transmitted accompanying the authorization request as a result of the performance of value-added services by the transaction processing server 812. In some embodiments, the authorization request may be transmitted to a transaction processor (e.g., owned or operated by the transaction processing server 812) situated at the issuing financial institution 802 or an entity associated thereof, which may forward the authorization request to the issuing financial institution 802.

In step 840, the issuing financial institution 802 may authorize the transaction account for payment of the payment transaction. The authorization may be based on an available credit amount for the transaction account and the transaction amount for the payment transaction, fraud scores provided by the transaction processing server 812, and other considerations that will be apparent to persons having skill in the relevant art. The issuing financial institution 802 may modify the authorization request to include a response code indicating approval (e.g., or denial if the transaction is to be denied) of the payment transaction. The issuing financial institution 802 may also modify a message type indicator for the transaction message to indicate that the transaction message is changed to be an authorization response. In step 842, the issuing financial institution 802 may transmit (e.g., via a transaction processor) the authorization response to the transaction processing server 812.

In step 844, the transaction processing server 812 may forward the authorization response to the acquiring financial institution 810 (e.g., via a transaction processor). In step 846, the acquiring financial institution may generate a response message indicating approval or denial of the payment transaction as indicated in the response code of the authorization response, and may transmit the response message to the gateway processor 808 using the standards and protocols set forth by the gateway processor 808. In step 848, the gateway processor 808 may forward the response message to the merchant 806 using the appropriate standards and protocols. In step 880, assuming the transaction was approved, the merchant 806 may then provide the products purchased by the consumer 804 as part of the payment transaction to the consumer 804.

In some embodiments, once the process 800 has completed, payment from the issuing financial institution 802 to the acquiring financial institution 810 may be performed. In some instances, the payment may be made immediately or within one business day. In other instances, the payment may be made after a period of time, and in response to the submission of a clearing request from the acquiring financial institution 810 to the issuing financial institution 802 via the transaction processing server 802. In such instances, clearing requests for multiple payment transactions may be aggregated into a single clearing request, which may be used by the transaction processing server 812 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 840), the transaction processing server 812 may be configured to perform authorization of transactions on behalf of the issuing financial institution 802. Such actions may be referred to as “stand-in processing,” where the transaction processing server “stands in” as the issuing financial institution 802. In such instances, the transaction processing server 812 may utilize rules set forth by the issuing financial institution 802 to determine approval or denial of the payment transaction, and may modify the transaction message accordingly prior to forwarding to the acquiring financial institution 810 in step 844. The transaction processing server 812 may retain data associated with transactions for which the transaction processing server 812 stands in, and may transmit the retained data to the issuing financial institution 802 once communication is reestablished. The issuing financial institution 802 may then process transaction accounts accordingly to accommodate for the time of lost communication.

In another example, if the transaction processing server 812 is unavailable for submission of the authorization request by the acquiring financial institution 810, then the transaction processor at the acquiring financial institution 810 may be configured to perform the processing of the transaction processing server 812 and the issuing financial institution 802. The transaction processor may include rules and data suitable for use in making a determination of approval or denial of the payment transaction based on the data included therein. For instance, the issuing financial institution 802 and/or transaction processing server 812 may set limits on transaction type, transaction amount, etc. that may be stored in the transaction processor and used to determine approval or denial of a payment transaction based thereon. In such instances, the acquiring financial institution 810 may receive an authorization response for the payment transaction even if the transaction processing server 812 is unavailable, ensuring that transactions are processed and no downtime is experienced even in instances where communication is unavailable. In such cases, the transaction processor may store transaction details for the payment transactions, which may be transmitted to the transaction processing server 812 (e.g., and from there to the associated issuing financial institutions 802) once communication is reestablished.

In some embodiments, transaction processors may be configured to include a plurality of different communication channels, which may utilize multiple communication cards and/or devices, to communicate with the transaction processing server 812 for the sending and receiving of transaction messages. For example, a transaction processor may be comprised of multiple computing devices, each having multiple communication ports that are connected to the transaction processing server 812. In such embodiments, the transaction processor may cycle through the communication channels when transmitting transaction messages to the transaction processing server 812, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 810 may identify that an authorization request involves an issuing financial institution 802 (e.g., via the bank identification number included in the transaction message) for which no value-added services are required. The transaction processor at the acquiring financial institution 810 may then transmit the authorization request directly to the transaction processor at the issuing financial institution 802 (e.g., without the authorization request passing through the transaction processing server 812), where the issuing financial institution 802 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 812 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 808, acquiring financial institution 810, etc.) for processing using this advanced network, and to quickly and efficiently receive a response regarding the ability for a consumer 804 to fund the payment transaction.

### Computer System Architecture

FIG. 9 is a block diagram illustrating a computer system architecture in accordance with exemplary embodiments.

FIG. 9 illustrates a computer system 900 in which embodiments of the present disclosure, or portions thereof, may be implemented as computer-readable code. For example, the first computing device 104 and first computing device 106 of FIG. 1 and the computing device 200 of FIG. 2 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B 4, 5A, 5B, and 6-8.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device specifically configured to perform the functions discussed herein. The processor device 904 may be connected to a communications infrastructure 906, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive or universal serial bus port, the removable storage unit 918 may be a floppy disk or portable flash drive, respectively. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

The computer system 900 may further include a display interface 902. The display interface 902 may be configured to allow data to be transferred between the computer system 900 and external display 930. Exemplary display interfaces 902 may include high-definition multimedia interface (HDMI), digital visual interface (DVI), video graphics array (VGA), etc. The display 930 may be any suitable type of display for displaying data transmitted via the display interface 902 of the computer system 900, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 908 and secondary memory 910, which may be memory semiconductors (e.g., DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 3, 4, 5A, 5B, 6, and 7, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

The processor device 904 may comprise one or more modules or engines configured to perform the functions of the computer system 900. Each of the modules or engines may be implemented using hardware and, in some instances, may also utilize software, such as corresponding to program code and/or programs stored in the main memory 908 or secondary memory 910. In such instances, program code may be compiled by the processor device 904 (e.g., by a compiling module or engine) prior to execution by the hardware of the computer system 900. For example, the program code may be source code written in a programming language that is translated into a lower level language, such as assembly language or machine code, for execution by the processor device 904 and/or any additional hardware components of the computer system 900. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 900 to perform the functions disclosed herein. It will be apparent to persons having skill in the relevant art that such processes result in the computer system 900 being a specially configured computer system 900 uniquely programmed to perform the functions discussed above.

Techniques consistent with the present disclosure provide, among other features, systems and methods for processing point to point payment transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for recording point to point payment transactions, comprising:
receiving, by a receiving device of a processing server, a first data message related to a payment transaction, wherein the first data message is formatted pursuant to one or more standards, is received using one or more application program interfaces (APIs), and includes at least a plurality of data elements including at least a first data element configured to store a transaction details, a second data element configured to store a primary account number, and a third data element configured to store a recipient account number;
storing, in a commerce database of the processing server, the first, second and third data element with a link to a record affiliated with the first data message, wherein the link provides access to a document based on the first data message;
generating, by a generation module of the processing server, a second data message related to the payment transaction, wherein the second data message is formatted pursuant to one or more standards and includes at least a plurality of data elements including a first data element configured to store a payment amount, the payment amount being based on at least the transaction details;
storing, in the commerce database of the processing server, the first data element with a link to a record affiliated with the second data message, wherein the link provides access to a document based on the second data message;
electronically transmitting, by a transmitting device of the processing server, the second data message to a first financial institution associated with a transaction account related to the primary account number;
generating, by the generation module of the processing server, a third data message related to the payment transaction, wherein the third data message is formatted pursuant to one or more standards and includes at least a plurality of data elements including a first data element configured to store a settlement amount and a second data element configured to store the recipient account number, the settlement amount being based on at least the transaction details;
storing, in the commerce database of the processing server, the first data element, and the second data element with a link to a record affiliated with the third data message, wherein the link provides access to a document based on the third data message;
electronically transmitting, by the transmitting device of the processing server, the third data message to a second financial institution associated with a transaction account related to the recipient account number; and
electronically transmitting, by transmitting device of the processing server, the first data message, the second data message, the third data message for display on a graphical user interface (GUI).

2. The method of claim 1, wherein the first data message, second data message, and third data message are formatted pursuant to the ISO 8583 standard.

3. The method of claim 1, wherein
the first data message is formatted pursuant to the ISO 8583 standard; and
the second data message and third data message are formatted pursuant to the ISO 20022 standard.

4. The method of claim 3, wherein the generating the second data message includes converting the first data message to the second data message based on correspondences between the ISO 8583 standard and the ISO 20022 standard.

5. The method of claim 1, wherein transaction details comprises one or more of: a transaction amount, order date, fulfillment date, and status.

6. The method of claim 1, wherein the settlement amount is equivalent to the transaction details.

7. The method of claim 1, further comprising:
generating, by a generation module of the processing server, a fourth data message related to the payment transaction, wherein the fourth data message is formatted pursuant to a standard and includes a plurality of data elements including at least a first data element configured to store the transaction details and a second data element configured to store the recipient account number; and
electronically transmitting, by a transmitting device of the processing server, the fourth data message.

8. The method of claim 7, wherein the fourth data message is electronically transmitted to the second financial institution.

9. The method of claim 7, wherein the first data message is received from and the fourth data message is electronically transmitted to a third party system.

10. The method of claim 7, wherein the fourth data message is formatted pursuant to the ISO 8583 standard.

11. The method of claim 1, wherein
the processing server includes a first computing device and a second computing device,
the first computing device includes the receiving device, and
the second computing device includes the generation module, determination module, and the transmitting device.

12. The method of claim 11, further comprising:
generating, by a generation module of the first computing device of the processing server, a data signal superimposed with at least the payment amount;
electronically transmitting, by a transmitting device of the first computing device of the processing server, the generated data signal to the second computing device; and
receiving, by a receiving device of the second computing device of the processing server, the data signal.

13. The method of claim 1, wherein the data elements stored in the commerce database comprise of a trade directory.

14. The method of claim 1, wherein the data elements stored in the commerce database comprise of a ledger.

15. A system for recording point to point payment transactions, comprising:
a receiving device of a processing server configured to receive a first data message related to a payment transaction, wherein the first data message is formatted pursuant to one or more standards, is received using one or more application program interfaces (APIs), and includes at least a plurality of data elements including at least a first data element configured to store a transaction details, a second data element configured to store a primary account number, and a third data element configured to store a recipient account number;
a commerce database of the processing server configured to store the first, second and third data element with a link to a record affiliated with the first data message, wherein the link provides access to a document based on the first data message;
a generation module of the processing server configured to generate a second data message related to the payment transaction, wherein the second data message is formatted pursuant to one or more standards and includes at least a plurality of data elements including a first data element configured to store a payment amount, the payment amount being based on at least the transaction details;
the commerce database of the processing server configured to store the first data element with a link to a record affiliated with the second data message, wherein the link provides access to a document based on the second data message;
a transmitting device of the processing server configured to electronically transmit the second data message to a first financial institution associated with a transaction account related to the primary account number;
the generation module of the processing server configured to generate a third data message related to the payment transaction, wherein the third data message is formatted pursuant to one or more standards and includes at least a plurality of data elements including a first data element configured to store a settlement amount and a second data element configured to store the recipient account number, the settlement amount being based on at least the transaction details;
the commerce database of the processing server configured to store the first data element, and the second data element with a link to a record affiliated with the third data message, wherein the link provides access to a document based on the third data message;
the transmitting device of the processing server configured to:
transmit the third data message to a second financial institution associated with a transaction account related to the recipient account number; and
transmit the first data message, the second data message, the third data message for display on a graphical user interface (GUI).

16. The system of claim 15, wherein the first data message, second data message, and third data message are formatted pursuant to the ISO 8583 standard.

17. The system of claim 15, wherein
the first data message is formatted pursuant to the ISO 8583 standard; and
the second data message and third data message are formatted pursuant to the ISO 20022 standard.

18. The system of claim 17, wherein the generating the second data message includes converting the first data message to the second data message based on correspondences between the ISO 8583 standard and the ISO 20022 standard.

19. The system of claim 15, wherein transaction details comprises one or more of:
a transaction amount, order date, fulfillment date, and status.

20. The system of claim 15, wherein the settlement amount is equivalent to the transaction details.

21. The system of claim 15, further comprising:
a generation module of the processing server configured to generate a fourth data message related to the payment transaction, wherein the fourth data message is formatted pursuant to a standard and includes a plurality of data elements including at least a first data element configured to store the transaction details and a second data element configured to store the recipient account number; and
the transmitting device of the processing server configured to transmit the fourth data message.

22. The system of claim 21, wherein the fourth data message is electronically transmitted to the second financial institution.

23. The system of claim 21, wherein the first data message is received from and the fourth data message is electronically transmitted to a third party system.

24. The system of claim 21, wherein the fourth data message is formatted pursuant to the ISO 8583 standard.

25. The system of claim 15, wherein
the processing server includes a first computing device and a second computing device,
the first computing device includes the receiving device, and
the second computing device includes the generation module, determination module, and the transmitting device.

26. The system of claim 25, further comprising:
a generation module of the first computing device of the processing server configured to generate a data signal superimposed with at least the payment amount;
a transmitting device of the first computing device of the processing server, configured to transmit the generated data signal to the second computing device; and
a receiving device of the second computing device of the processing server configured to receive the data signal.

27. The system of claim 15, wherein the data elements stored in the commerce database comprise of a trade directory.

28. The system of claim 15, wherein the data elements stored in the commerce database comprise of a ledger.
